(19) United States
(12) Patent Application Publication
(10) Pub. No.: US 2025/0047429 A1
(43) Pub. Date: Feb. 6, 2025

(54) COMMUNICATION METHOD AND APPARATUS

(71) Applicant: HUAWEI TECHNOLOGIES CO., LTD., Shenzhen, Guangdong (CN)

(72) Inventors: Chuili KONG, Hangzhou (CN); Yunfei QIAO, Hangzhou (CN); Feiran ZHAO, Hangzhou (CN)

(73) Assignee: HUAWEI TECHNOLOGIES CO., LTD., Shenzhen, Guangdong, GD (CN)

(21) Appl. No.: 18/920,909

(22) Filed: Oct. 20, 2024

Related U.S. Application Data
(63) Continuation of application No. PCT/CN2023/088723, filed on Apr. 17, 2023.

(30) Foreign Application Priority Data
Apr. 20, 2022 (CN) 202210417976.3

(51) Int. Cl. H04L 5/00

(52) U.S. Cl. CPC H04L 5/0005; H04L 5/0098

(57) ABSTRACT

This application provides a communication method and apparatus, to resolve a problem that a quantity of supported beams in an existing solution is limited and therefore a large-scale cell cannot be fully covered, thereby improving reliability of initial access of terminal devices in the large-scale cell. The communication method and apparatus are applicable to various communication systems, for example, an NTN system, a satellite communication system, an aerial platform communication system, an uncrewed aerial vehicle communication system, a 5G system, an internet of vehicles system, and a V2X system. The method includes: generating N SSBs, where N≤Lₘₐₓ, Lₘₐₓ>64, Lₘₐₓ is a maximum quantity of supported sent SSBs, and N is a quantity of SSBs actually sent in one SSB cycle; and sending the N SSBs, where the N SSBs each carry an index i, and i is one of {0, 1, . . . , N−1}.

### CROSS-REFERENCE TO RELATED APPLICATIONS

This application is a continuation of International Application No. PCT/CN2023/088723, filed on Apr. 17, 2023, which claims priority to Chinese Patent Application No. 202210417976.3, filed on Apr. 20, 2022. The disclosures of the aforementioned applications are hereby incorporated by reference in their entireties.

### TECHNICAL FIELD

This application relates to the communication field, and in particular, to a communication method and apparatus.

### BACKGROUND

Currently, a terminal device receives a synchronization signal/physical broadcast channel block (synchronization signal/physical broadcast channel block, SSB) sent by a network device, obtains downlink synchronization and a master information block (master information block, MIB), and obtains position information of a system information block (system information block, SIB) 1 and remaining minimum system information (remaining minimum system information, RMSI) based on the MIB; and then obtains, based on the position information, information about a type 0 physical downlink control channel (type 0 physical downlink control channel, type 0-PDCCH) carrying a control resource set 0 (control resource set, CORESET 0) #0 and information about a physical downlink shared channel (physical downlink shared channel, PDSCH) carrying the SIB 1, and demodulates the SIB 1 to obtain configuration information of random access, to initiate a random access procedure to the network device, to complete initial access.

In the foregoing initial access process, downlink signaling such as the SSB, the CORESET 0 #0, and the SIB 1 may be sent through beams. Generally, a plurality of beams are usually configured for one cell, different beams cover different areas in the cell, and all the beams cover all areas in the cell, to meet initial access requirements of terminal devices located in different areas in the cell.

However, in an existing protocol, only a maximum of 64 beams can be supported. When a cell requires a relatively large coverage area but a coverage area of a single beam is limited, existing beams are insufficient to support an initial access requirement of the entire cell. For example, in satellite communication, a coverage area of a single satellite is large, but a maximum quantity of supported beams is still 64. Therefore, a satellite cell cannot be fully covered, and reliability of initial access of some terminal devices in the satellite cell may be affected.

### SUMMARY

Embodiments of this application provide a communication method and apparatus, to resolve a problem that a quantity of supported beams in an existing solution is limited and therefore a large-scale cell cannot be fully covered, thereby improving reliability of initial access of terminal devices in the large-scale cell.

To achieve the foregoing objective, this application uses the following technical solutions:

According to a first aspect, a communication method is provided. The method includes: generating N SSBs, where the N SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle; and sending the N SSBs.

Based on the methods according to the first aspect and the following second aspect, the network device may support more than 64 SSBs, for example, 256 or 1024 SSBs, and actually send N of the more than 64 SSBs in one SSB cycle, to meet a full-area coverage requirement of a large-scale area (for example, a satellite cell), so that a terminal device located at any position in the area can receive at least one SSB, to implement initial access, thereby improving reliability of an initial access procedure of a large-scale cell.

In a possible design solution, the sending the N SSBs may include: sending the N SSBs on first resources; sending, on second resources, control resource sets CORESETs 0 respectively corresponding to the N SSBs, where a time-frequency offset between the second resource and the first resource is a first offset; and sending, on third resources, system messages SIBs 1 respectively corresponding to the N SSBs, where a time-frequency offset between the third resource and the first resource is a second offset. To be specific, the SSB, the CORESET 0 corresponding to the SSB, and the SIB 1 corresponding to the SSB may be separately transmitted on different time-frequency resources. In addition, there is a fixed time-frequency offset between the first resource for transmitting the SSB and the second resource for transmitting the CORESET 0, and there is a fixed time-frequency offset between the first resource for transmitting the SSB and the third resource for transmitting the SIB 1. Therefore, configuration information of these resources does not need to be transmitted, and saved signaling resources can be used to transmit an SSB index, to resolve a problem that signaling resources for transmitting an SSB index are insufficient when a maximum quantity of sent SSBs supported by a network increases, thereby improving reliability.

Optionally, in two adjacent SSBs, a second resource and a third resource that correspond to a current SSB are located, in time domain, in front of a first resource corresponding to a next SSB. In other words, a CORESET 0 and a SIB 1 that correspond to a same SSB can be transmitted together with the SSB in as short time as possible. In this way, a terminal device that receives the SSB can also receive the CORESET 0 and the SIB 1 in relatively short time, to initiate a random access procedure as early as possible, thereby completing initial access as soon as possible, and improving initial access efficiency.

Further, the first resource, the second resource, and the third resource may be contiguous in time domain and/or contiguous in frequency domain, to more densely transmit the SSB and the CORESET 0 and the SIB 1 that correspond to the SSB, thereby further reducing an initial access delay, and improving initial access efficiency.

Optionally, the first resource may occupy, in time domain, four symbols whose symbol indexes are {0, 1, 2, 3}, and may occupy, in frequency domain, 240 subcarriers whose subcarrier indexes are {0, 1, . . . , 239}; and the first resource may include a fourth resource occupied by a physical broadcast channel PBCH, and the fourth resource may include subcarriers whose subcarrier indexes are {0, 1, . . . , 238, 239} on a symbol 1 and a symbol 3 and subcarriers whose subcarrier indexes are {0, 1, . . . , 47} and {192, 193, . . . , 239} on a symbol 2. Further, the fourth resource may further include some or all of the following one or more subcarriers: subcarriers whose subcarrier indexes are {0, 1, . . . , 55} on a symbol 0, subcarriers whose subcarrier indexes are {183, 184, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2. To be specific, as a quantity of supported SSBs increases, a data amount (a quantity of bits) of the SSB index also increases. Therefore, a quantity of resources of the PBCH for transmitting the SSB index may be increased. For example, the SSB index may be transmitted by using a resource that is spare for the SSB but is not actually used, to resolve a problem of insufficient resources for transmitting an SSB index with a larger data amount. In addition, these added resources and original PBCH resources all belong to resources configured for the SSB, and no additional time-frequency resource needs to be added. In this way, transmission of other signaling and/or data is not affected, thereby improving communication efficiency.

Optionally, some bits in the index i may be carried by reusing a first information element and/or a second information element, to improve resource utilization, thereby improving efficiency. The first information element may include one or more of the following items in a master information block MIB: a common subcarrier spacing (SubCarrierSpacingCommon), an SSB subcarrier offset (SubcarrierOffset), a time domain position (dmrs-TypeA-Position) of a physical downlink shared channel PDSCH carrying a system information block SIB 1, configuration information (pdcch-ConfigSIB1) of a physical downlink control channel PDCCH related to the SIB 1, or a spare (spare) bit. The second information element may include one or more of the following items in a physical broadcast channel PBCH payload: a half frame indication (Half Frame Indication) or X least significant bits in 4 least significant bits of a system frame number (4th LSB of SFN), where X meets the following condition: X≥1 and a time length of 2 raised to the power of X system frames is greater than transmission duration of Lₘₐₓ SSBS.

According to a second aspect, a communication method is provided. The method includes: receiving one or more SSBs, where the one or more SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle; and receiving control resource sets 0 CORESETs 0 respectively corresponding to the one or more SSBs.

It may be understood that the one or more SSBs are some of N SSBs generated by a network device.

In a possible design solution, the receiving one or more SSBs may include: receiving the one or more SSBs on first resources; receiving, on second resources, the control resource sets 0 CORESETs 0 respectively corresponding to the one or more SSBs, where a time-frequency offset between the second resource and the first resource is a first offset; and receiving, on third resources, system messages 1 SIBs 1 respectively corresponding to the one or more SSBs, where a time-frequency offset between the third resource and the first resource is a second offset.

Optionally, in two adjacent SSBs, a second resource and a third resource that correspond to a current SSB are located, in time domain, in front of a first resource corresponding to a next SSB.

Optionally, the first resource may occupy, in time domain, four symbols whose symbol indexes are {0, 1, 2, 3}, and may occupy, in frequency domain, 240 subcarriers whose subcarrier indexes are {0, 1, . . . , 239}; and the first resource may include a fourth resource occupied by a physical broadcast channel PBCH, and the fourth resource may include subcarriers whose subcarrier indexes are {0, 1, . . . , 238, 239} on a symbol 1 and a symbol 3 and subcarriers whose subcarrier indexes are {0, 1, . . . , 47} and {192, 193, . . . , 239} on a symbol 2. Further, the fourth resource may further include some or all of the following one or more subcarriers: subcarriers whose subcarrier indexes are {0, 1, . . . , 47} on a symbol 0, subcarriers whose subcarrier indexes are {192, 193, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2.

In a possible design solution, some bits in the index i may be carried by reusing a first information element and/or a second information element. The first information element may include one or more of the following items in a master information block MIB: a common subcarrier spacing, an SSB subcarrier offset, a time domain position of a physical downlink shared channel PDSCH carrying a system information block SIB 1, configuration information of a physical downlink control channel PDCCH related to the SIB 1, or a spare bit. The second information element may include one or more of the following items in a physical broadcast channel PBCH payload: a half frame indication or X least significant bits in 4 least significant bits of a system frame number, where X meets the following condition: X≥1 and a time length of 2 raised to the power of X system frames is greater than transmission duration of Lₘₐₓ SSBs.

In addition, for technical effects of the communication method according to the second aspect, refer to the technical effects of the communication method according to the first aspect. Details are not described herein again.

According to a third aspect, a communication method is provided. The method includes: sending N SSBs on first resources, where the N SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle; sending, on second resources, control resource sets CORESETs 0 respectively corresponding to the N SSBs, where a time-frequency offset between the second resource and the first resource is a first offset; and sending, on third resources, system messages SIBs 1 respectively corresponding to the N SSBs, where a time-frequency offset between the third resource and the first resource is a second offset.

Based on the methods according to the third aspect and the following fourth aspect, when the maximum quantity of supported sent SSBs is greater than 64, for example, 256 or 1024, the SSB, the CORESET 0 corresponding to the SSB, and the SIB 1 corresponding to the SSB may be separately transmitted on different time-frequency resources. In addition, there is a fixed time-frequency offset between the first resource for transmitting the SSB and the second resource for transmitting the CORESET 0, and there is a fixed time-frequency offset between the first resource for transmitting the SSB and the third resource for transmitting the SIB 1. Therefore, configuration information of these resources does not need to be transmitted, and saved signaling resources can be used to transmit an SSB index, to resolve a problem that signaling resources for transmitting an SSB index are insufficient when a maximum quantity of sent SSBs supported by a network increases, thereby improving reliability.

In a possible design solution, in two adjacent SSBs, a second resource and a third resource that correspond to a current SSB are located, in time domain, in front of a first resource corresponding to a next SSB. In other words, a CORESET 0 and a SIB 1 that correspond to a same SSB can be transmitted together with the SSB in as short time as possible. In this way, a terminal device that receives the SSB can also receive the CORESET 0 and the SIB 1 in relatively short time, to initiate a random access procedure as early as possible, thereby completing initial access as soon as possible, and improving initial access efficiency.

Further, the first resource, the second resource, and the third resource may be contiguous in time domain and/or contiguous in frequency domain, to more densely transmit the SSB and the CORESET 0 and the SIB 1 that correspond to the SSB, thereby further reducing an initial access delay, and improving initial access efficiency.

In a possible design solution, some bits in the index i may be carried by reusing a first information element and/or a second information element, to save resources, thereby further improving efficiency. The first information element may include one or more of the following items in a master information block MIB: a common subcarrier spacing, an SSB subcarrier offset, a time domain position of a physical downlink shared channel PDSCH carrying a system information block SIB 1, configuration information of a physical downlink control channel PDCCH related to the SIB 1, or a spare bit. The second information element may include one or more of the following items in a physical broadcast channel PBCH payload: a half frame indication or X least significant bits in 4 least significant bits of a system frame number, where X meets the following condition: X≥1 and a time length of 2 raised to the power of X system frames is greater than transmission duration of Lₘₐₓ SSBs.

According to a fourth aspect, a communication method is provided. The method includes: receiving one or more SSBs on first resources, where the one or more SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle; receiving, on second resources, control resource sets 0 CORESETs 0 respectively corresponding to the one or more SSBs, where a time-frequency offset between the second resource and the first resource is a first offset; and receiving, on third resources, system messages 1 SIBs 1 respectively corresponding to the one or more SSBs, where a time-frequency offset between the third resource and the first resource is a second offset.

It may be understood that the one or more SSBs are some of N SSBs generated by a network device.

In a possible design solution, in two adjacent SSBs, a second resource and a third resource that correspond to a current SSB are located, in time domain, in front of a first resource corresponding to a next SSB.

In a possible design solution, some bits in the index i may be carried by reusing a first information element and/or a second information element. The first information element may include one or more of the following items in a master information block MIB: a common subcarrier spacing, an SSB subcarrier offset, a time domain position of a physical downlink shared channel PDSCH carrying a system information block SIB 1, configuration information of a physical downlink control channel PDCCH related to the SIB 1, or a spare bit. The second information element may include one or more of the following items in a physical broadcast channel PBCH payload: a half frame indication or X least significant bits in 4 least significant bits of a system frame number, where X meets the following condition: X≥1 and a time length of 2 raised to the power of X system frames is greater than transmission duration of Lₘₐₓ SSBs.

In addition, for technical effects of the communication method according to the fourth aspect, refer to the technical effects of the communication method according to the third aspect. Details are not described herein again.

According to a fifth aspect, a communication method is provided. The method includes: generating N SSBs, where the N SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle; and sending the N SSBs on first resources. The first resource occupies, in time domain, four symbols whose symbol indexes are {0, 1, 2, 3}, and occupies, in frequency domain, 240 subcarriers whose subcarrier indexes are {0, 1, . . . , 239}; and the first resource includes a fourth resource occupied by a physical broadcast channel PBCH, and the fourth resource includes subcarriers whose subcarrier indexes are {0, 1, . . . , 238, 239} on a symbol 1 and a symbol 3 and subcarriers whose subcarrier indexes are {0, 1, . . . , 47} and {192, 193, . . . , 239} on a symbol 2. The fourth resource further includes some or all of the following one or more subcarriers: subcarriers whose subcarrier indexes are {0, 1, . . . , 55} on a symbol 0, subcarriers whose subcarrier indexes are {183, 184, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2.

Based on the methods according to the fifth aspect and the following sixth aspect, as a maximum quantity of supported sent SSBs increases, for example, increases to 256 or 1024, a data amount (a quantity of bits) of the SSB index also increases. Therefore, a quantity of resources of the PBCH for transmitting the SSB index may be increased. For example, the SSB index may be transmitted by using a resource that is spare for the SSB but is not actually used, to resolve a problem of insufficient resources for transmitting an SSB index with a larger data amount. In addition, these added resources and original PBCH resources all belong to resources configured for the SSB, and no additional time-frequency resource needs to be added. In this way, transmission of other signaling and/or data is not affected, thereby improving communication efficiency.

According to a sixth aspect, a communication method is provided. The method includes: receiving one or more SSBs on first resources, where the one or more SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle, where the first resource occupies, in time domain, four symbols whose symbol indexes are {0, 1, 2, 3}, and occupies, in frequency domain, 240 subcarriers whose subcarrier indexes are {0, 1, . . . , 239}; and the first resource includes a fourth resource occupied by a physical broadcast channel PBCH, and the fourth resource includes subcarriers whose subcarrier indexes are {0, 1, . . . , 238, 239} on a symbol 1 and a symbol 3 and subcarriers whose subcarrier indexes are {0, 1, . . . , 47} and {192, 193, . . . , 239} on a symbol 2; and the fourth resource further includes some or all of the following one or more subcarriers: subcarriers whose subcarrier indexes are {0, 1, . . . , 55} on a symbol 0, subcarriers whose subcarrier indexes are {183, 184, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2; and receiving control resource sets 0 CORESETs 0 respectively corresponding to the one or more SSBs.

It may be understood that the one or more SSBs are some of N SSBs generated by a network device.

In addition, for technical effects of the communication method according to the sixth aspect, refer to the technical effects of the communication method according to the fifth aspect. Details are not described herein again.

According to a seventh aspect, a communication method is provided. The method includes: generating N SSBs, where the N SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle; and sending the N SSBs, where some bits in the index i are carried by reusing a spare bit in a master information block MIB and/or a second information element, where the second information element includes one or more of the following items: a half frame indication or X least significant bits in 4 least significant bits of a system frame number in a physical broadcast channel PBCH payload, where X meets the following condition: X≥1 and a time length of 2 raised to the power of X system frames is greater than transmission duration of Lₘₐₓ SSBs.

Based on the methods according to the seventh aspect and the following eighth aspect, as a maximum quantity of supported sent SSBs increases, for example, increases to 256 or 1024, a data amount (a quantity of bits) of the SSB index also increases. Therefore, the MIB and/or some information elements (information element, IE) in the PBCH payload (payload) may be multiplexed to transmit the SSB index, to improve resource utilization and efficiency.

For example, the SSB index may be transmitted by using a resource that is spare for the SSB but is not actually used, to resolve a problem of insufficient resources for transmitting an SSB index with a larger data amount. In addition, these added resources and original PBCH resources all belong to resources configured for the SSB, and no additional time-frequency resource needs to be added. In this way, transmission of other signaling and/or data is not affected, thereby improving communication efficiency.

According to an eighth aspect, a communication method is provided. The method includes: receiving one or more SSBs, where the one or more SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle, where some bits in the index i are carried by reusing a spare bit in a master information block MIB and/or a second information element, where the second information element includes one or more of the following items: a half frame indication or X least significant bits in 4 least significant bits of a system frame number in a physical broadcast channel PBCH payload, where X meets the following condition: X≥1 and a time length of 2 raised to the power of X system frames is greater than transmission duration of Lₘₐₓ SSBs; and receiving control resource sets 0 CORESETs 0 respectively corresponding to the one or more SSBs.

It may be understood that the one or more SSBs are some of N SSBs generated by a network device.

In addition, for technical effects of the communication method according to the eighth aspect, refer to the technical effects of the communication method according to the seventh aspect. Details are not described herein again.

According to a ninth aspect, a communication apparatus is provided. The apparatus includes a processing module and a sending module. The processing module is configured to generate N SSBs, where the N SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle. The sending module is configured to send the N SSBs.

In a possible design solution, the sending module is further configured to send the N SSBs on first resources. The sending module is further configured to send, on second resources, control resource sets CORESETs 0 respectively corresponding to the N SSBs, where a time-frequency offset between the second resource and the first resource is a first offset. The sending module is further configured to send, on third resources, system messages SIBs 1 respectively corresponding to the N SSBs, where a time-frequency offset between the third resource and the first resource is a second offset.

Optionally, in two adjacent SSBs, a second resource and a third resource that correspond to a current SSB are located, in time domain, in front of a first resource corresponding to a next SSB.

Optionally, the first resource may occupy, in time domain, four symbols whose symbol indexes are {0, 1, 2, 3}, and may occupy, in frequency domain, 240 subcarriers whose subcarrier indexes are {0, 1, . . . , 239}; and the first resource may include a fourth resource occupied by a physical broadcast channel PBCH, and the fourth resource may include subcarriers whose subcarrier indexes are {0, 1, . . . , 238, 239} on a symbol 1 and a symbol 3 and subcarriers whose subcarrier indexes are {0, 1, . . . , 47} and {192, 193, . . . , 239} on a symbol 2. Further, the fourth resource may further include some or all of the following one or more subcarriers: subcarriers whose subcarrier indexes are {0, 1, . . . , 55} on a symbol 0, subcarriers whose subcarrier indexes are {183, 184, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2.

In a possible design solution, some bits in the index i may be carried by reusing a first information element and/or a second information element. The first information element may include one or more of the following items in a master information block MIB: a common subcarrier spacing, an SSB subcarrier offset, a time domain position of a physical downlink shared channel PDSCH carrying a system information block SIB 1, configuration information of a physical downlink control channel PDCCH related to the SIB 1, or a spare bit. The second information element may include one or more of the following items in a physical broadcast channel PBCH payload: a half frame indication or X least significant bits in 4 least significant bits of a system frame number, where X meets the following condition: X≥1 and a time length of 2 raised to the power of X system frames is greater than transmission duration of Lₘₐₓ SSBs.

Optionally, the communication apparatus according to the ninth aspect may further include a receiving module. The receiving module is configured to implement a receiving function of the communication apparatus according to the ninth aspect. Further, the sending module and the receiving module may alternatively be disposed as one module, for example, a transceiver module. The transceiver module is configured to implement a sending and receiving function of the communication apparatus according to the ninth aspect.

Optionally, the communication apparatus according to the ninth aspect may further include a storage module. The storage module stores a program or instructions. When the processing module executes the program or the instructions, the communication apparatus is enabled to perform the communication method according to the first aspect.

It should be noted that, the communication apparatus according to the ninth aspect may be a network device, may be a chip (system) or another part or component that can be disposed in the network device, or may be an apparatus including the network device. This is not limited in this application.

According to a tenth aspect, a communication apparatus is provided. The apparatus includes a receiving module. The receiving module is configured to receive one or more SSBs, where the one or more SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle. The receiving module is further configured to receive control resource sets 0 CORESETs 0 respectively corresponding to the one or more SSBs.

It may be understood that the one or more SSBs are some of N SSBs generated by a network device.

In a possible design solution, the receiving module is further configured to receive the one or more SSBs on first resources. The receiving module is further configured to receive, on second resources, the control resource sets 0 CORESETs 0 respectively corresponding to the one or more SSBs, where a time-frequency offset between the second resource and the first resource is a first offset. The receiving module is further configured to receive, on third resources, system messages 1 SIBs 1 respectively corresponding to the one or more SSBs, where a time-frequency offset between the third resource and the first resource is a second offset.

Optionally, in two adjacent SSBs, a second resource and a third resource that correspond to a current SSB are located, in time domain, in front of a first resource corresponding to a next SSB.

Optionally, the first resource may occupy, in time domain, four symbols whose symbol indexes are {0, 1, 2, 3}, and may occupy, in frequency domain, 240 subcarriers whose subcarrier indexes are {0, 1, . . . , 239}; and the first resource may include a fourth resource occupied by a physical broadcast channel PBCH, and the fourth resource may include subcarriers whose subcarrier indexes are {0, 1, . . . , 238, 239} on a symbol 1 and a symbol 3 and subcarriers whose subcarrier indexes are {0, 1, . . . , 47} and {192, 193, . . . , 239} on a symbol 2. Further, the fourth resource may further include some or all of the following one or more subcarriers: subcarriers whose subcarrier indexes are {0, 1, . . . , 55} on a symbol 0, subcarriers whose subcarrier indexes are {183, 184, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2.

In a possible design solution, some bits in the index i may be carried by reusing a first information element and/or a second information element. The first information element may include one or more of the following items in a master information block MIB: a common subcarrier spacing, an SSB subcarrier offset, a time domain position of a physical downlink shared channel PDSCH carrying a system information block SIB 1, configuration information of a physical downlink control channel PDCCH related to the SIB 1, or a spare bit. The second information element may include one or more of the following items in a physical broadcast channel PBCH payload: a half frame indication or X least significant bits in 4 least significant bits of a system frame number, where X meets the following condition: X≥1 and a time length of 2 raised to the power of X system frames is greater than transmission duration of Lₘₐₓ SSBs.

Optionally, the communication apparatus according to the tenth aspect may further include a sending module. The sending module is configured to implement a sending function of the communication apparatus according to the tenth aspect. Further, the sending module and the receiving module may alternatively be disposed as one module, for example, a transceiver module. The transceiver module is configured to implement a sending and receiving function of the communication apparatus according to the tenth aspect.

Optionally, the communication apparatus according to the tenth aspect may further include a processing module and a storage module. The processing module is configured to implement a processing function of the communication apparatus according to the tenth aspect, and the storage module stores a program or instructions. When the processing module executes the program or the instructions, the communication apparatus is enabled to perform the communication method according to the second aspect.

It should be noted that, the communication apparatus according to the tenth aspect may be a terminal device, may be a chip (system) or another part or component that can be disposed in the terminal device, or may be an apparatus including the terminal device. This is not limited in this application.

In addition, for technical effects of the communication apparatuses according to the ninth aspect and the tenth aspect, refer to the technical effects of the communication method according to the first aspect. Details are not described herein again.

According to an eleventh aspect, a communication apparatus is provided. The apparatus includes a sending module. The sending module is configured to send N SSBs on first resources, where the N SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle. The sending module is further configured to send, on second resources, control resource sets CORESETs 0 respectively corresponding to the N SSBs, where a time-frequency offset between the second resource and the first resource is a first offset. The sending module is further configured to send, on third resources, system messages SIBs 1 respectively corresponding to the N SSBs, where a time-frequency offset between the third resource and the first resource is a second offset.

Optionally, in two adjacent SSBs, a second resource and a third resource that correspond to a current SSB are located, in time domain, in front of a first resource corresponding to a next SSB.

In a possible design solution, some bits in the index i may be carried by reusing a first information element and/or a second information element. The first information element may include one or more of the following items in a master information block MIB: a common subcarrier spacing, an SSB subcarrier offset, a time domain position of a physical downlink shared channel PDSCH carrying a system information block SIB 1, configuration information of a physical downlink control channel PDCCH related to the SIB 1, or a spare bit. The second information element may include one or more of the following items in a physical broadcast channel PBCH payload: a half frame indication or X least significant bits in 4 least significant bits of a system frame number, where X meets the following condition: X≥1 and a time length of 2 raised to the power of X system frames is greater than transmission duration of Lₘₐₓ SSBs.

Optionally, the communication apparatus according to the eleventh aspect may further include a receiving module. The receiving module is configured to implement a receiving function of the communication apparatus according to the eleventh aspect. Further, the sending module and the receiving module may alternatively be disposed as one module, for example, a transceiver module. The transceiver module is configured to implement a sending and receiving function of the communication apparatus according to the eleventh aspect.

Optionally, the communication apparatus according to the eleventh aspect may further include a processing module and a storage module. The processing module is configured to implement a processing function of the communication apparatus according to the eleventh aspect, and the storage module stores a program or instructions. When the processing module executes the program or the instructions, the communication apparatus is enabled to perform the communication method according to the third aspect.

It should be noted that, the communication apparatus according to the eleventh aspect may be a network device, may be a chip (system) or another part or component that can be disposed in the network device, or may be an apparatus including the network device. This is not limited in this application.

According to a twelfth aspect, a communication apparatus is provided. The apparatus includes a receiving module. The receiving module is configured to receive one or more SSBs on first resources, where the one or more SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle. The receiving module is further configured to receive, on second resources, control resource sets 0 CORESETs 0 respectively corresponding to the one or more SSBs, where a time-frequency offset between the second resource and the first resource is a first offset. The receiving module is further configured to receive, on third resources, system messages 1 SIBs 1 corresponding to the one or more SSBs, where a time-frequency offset between the third resource and the first resource is a second offset.

It may be understood that the one or more SSBs are some of N SSBs generated by a network device.

Optionally, in two adjacent SSBs, a second resource and a third resource that correspond to a current SSB are located, in time domain, in front of a first resource corresponding to a next SSB.

In a possible design solution, some bits in the index i may be carried by reusing a first information element and/or a second information element. The first information element may include one or more of the following items in a master information block MIB: a common subcarrier spacing, an SSB subcarrier offset, a time domain position of a physical downlink shared channel PDSCH carrying a system information block SIB 1, configuration information of a physical downlink control channel PDCCH related to the SIB 1, or a spare bit. The second information element may include one or more of the following items in a physical broadcast channel PBCH payload: a half frame indication or X least significant bits in 4 least significant bits of a system frame number, where X meets the following condition: X≥1 and a time length of 2 raised to the power of X system frames is greater than transmission duration of Lₘₐₓ SSBs.

Optionally, the communication apparatus according to the twelfth aspect may further include a sending module. The sending module is configured to implement a sending function of the communication apparatus according to the twelfth aspect. Further, the sending module and the receiving module may alternatively be disposed as one module, for example, a transceiver module. The transceiver module is configured to implement a sending and receiving function of the communication apparatus according to the twelfth aspect.

Optionally, the communication apparatus according to the twelfth aspect may further include a processing module and a storage module. The processing module is configured to implement a processing function of the communication apparatus according to the twelfth aspect, and the storage module stores a program or instructions. When the processing module executes the program or the instructions, the communication apparatus is enabled to perform the communication method according to the fourth aspect.

It should be noted that, the communication apparatus according to the twelfth aspect may be a terminal device, may be a chip (system) or another part or component that can be disposed in the terminal device, or may be an apparatus including the terminal device. This is not limited in this application.

In addition, for technical effects of the communication apparatuses according to the eleventh aspect and the twelfth aspect, refer to the technical effects of the communication method according to the third aspect. Details are not described herein again.

According to a thirteenth aspect, a communication apparatus is provided. The apparatus includes a processing module and a sending module. The processing module is configured to generate N SSBs, where the N SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle. The sending module is configured to send the N SSBs on first resources. The first resource occupies, in time domain, four symbols whose symbol indexes are {0, 1, 2, 3}, and occupies, in frequency domain, 240 subcarriers whose subcarrier indexes are {0, 1, . . . , 239}; and the first resource includes a fourth resource occupied by a physical broadcast channel PBCH, and the fourth resource includes subcarriers whose subcarrier indexes are {0, 1, . . . , 238, 239} on a symbol 1 and a symbol 3 and subcarriers whose subcarrier indexes are {0, 1, . . . , 47} and {192, 193, . . . , 239} on a symbol 2. The fourth resource further includes some or all of the following one or more subcarriers: subcarriers whose subcarrier indexes are {0, 1, . . . , 55} on a symbol 0, subcarriers whose subcarrier indexes are {183, 184, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2.

Optionally, the communication apparatus according to the thirteenth aspect may further include a receiving module. The receiving module is configured to implement a receiving function of the communication apparatus according to the thirteenth aspect. Further, the sending module and the receiving module may alternatively be disposed as one module, for example, a transceiver module. The transceiver module is configured to implement a sending and receiving function of the communication apparatus according to the thirteenth aspect.

Optionally, the communication apparatus according to the thirteenth aspect may further include a storage module. The storage module stores a program or instructions. When the processing module executes the program or the instructions, the communication apparatus is enabled to perform the communication method according to the fifth aspect.

It should be noted that, the communication apparatus according to the thirteenth aspect may be a network device, may be a chip (system) or another part or component that can be disposed in the network device, or may be an apparatus including the network device. This is not limited in this application.

According to a fourteenth aspect, a communication apparatus is provided. The apparatus includes a receiving module. The receiving module is configured to receive one or more SSBs on first resources, where the one or more SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle. The first resource occupies, in time domain, four symbols whose symbol indexes are {0, 1, 2, 3}, and occupies, in frequency domain, 240 subcarriers whose subcarrier indexes are {0, 1, . . . , 239}; and the first resource includes a fourth resource occupied by a physical broadcast channel PBCH, and the fourth resource includes subcarriers whose subcarrier indexes are {0, 1, . . . , 238, 239} on a symbol 1 and a symbol 3 and subcarriers whose subcarrier indexes are {0, 1, . . . , 47} and {192, 193, . . . , 239} on a symbol 2. The fourth resource further includes some or all of the following one or more subcarriers: subcarriers whose subcarrier indexes are {0, 1, . . . , 55} on a symbol 0, subcarriers whose subcarrier indexes are {183, 184, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2. The receiving module is further configured to receive control resource sets 0 CORESETs 0 respectively corresponding to the one or more SSBs.

It may be understood that the one or more SSBs are some of N SSBs generated by a network device.

Optionally, the communication apparatus according to the fourteenth aspect may further include a sending module. The sending module is configured to implement a sending function of the communication apparatus according to the fourteenth aspect. Further, the sending module and the receiving module may alternatively be disposed as one module, for example, a transceiver module. The transceiver module is configured to implement a sending and receiving function of the communication apparatus according to the fourteenth aspect.

Optionally, the communication apparatus according to the fourteenth aspect may further include a processing module and a storage module. The processing module is configured to implement a processing function of the communication apparatus according to the fourteenth aspect, and the storage module stores a program or instructions. When the processing module executes the program or the instructions, the communication apparatus is enabled to perform the communication method according to the sixth aspect.

It should be noted that, the communication apparatus according to the fourteenth aspect may be a terminal device, may be a chip (system) or another part or component that can be disposed in the terminal device, or may be an apparatus including the terminal device. This is not limited in this application.

In addition, for technical effects of the communication apparatuses according to the thirteenth aspect and the fourteenth aspect, refer to the technical effects of the communication method according to the fifth aspect. Details are not described herein again.

According to a fifteenth aspect, a communication apparatus is provided. The apparatus includes a processing module and a sending module. The processing module is configured to generate N SSBs, where the N SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle. The sending module is configured to send the N SSBs. Some bits in the index i are carried by reusing a spare bit in a master information block MIB and/or a second information element, where the second information element includes one or more of the following items: a half frame indication or X least significant bits in 4 least significant bits of a system frame number in a physical broadcast channel PBCH payload, where X meets the following condition: X≥1 and a time length of 2 raised to the power of X system frames is greater than transmission duration of Lₘₐₓ SSBs.

Optionally, the communication apparatus according to the fifteenth aspect may further include a receiving module. The receiving module is configured to implement a receiving function of the communication apparatus according to the fifteenth aspect. Further, the sending module and the receiving module may alternatively be disposed as one module, for example, a transceiver module. The transceiver module is configured to implement a receiving function of the communication apparatus according to the fifteenth aspect.

Optionally, the communication apparatus according to the fifteenth aspect may further include a storage module. The storage module stores a program or instructions. When the processing module executes the program or the instructions, the communication apparatus is enabled to perform the communication method according to the seventh aspect.

It should be noted that, the communication apparatus according to the fifteenth aspect may be a network device, may be a chip (system) or another part or component that can be disposed in the network device, or may be an apparatus including the network device. This is not limited in this application.

According to a sixteenth aspect, a communication apparatus is provided. The apparatus includes a receiving module. The receiving module is configured to receive one or more SSBs, where the one or more SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle, where some bits in the index i are carried by reusing a spare bit in a master information block MIB and/or a second information element, where the second information element includes one or more of the following items: a half frame indication or X least significant bits in 4 least significant bits of a system frame number in a physical broadcast channel PBCH payload, where X meets the following condition: X≥1 and a time length of 2 raised to the power of X system frames is greater than transmission duration of Lₘₐₓ SSBs. The receiving module is further configured to receive control resource sets 0 CORESETs 0 respectively corresponding to the one or more SSBs.

It may be understood that the one or more SSBs are some of N SSBs generated by a network device.

Optionally, the communication apparatus according to the sixteenth aspect may further include a sending module. The sending module is configured to implement a sending function of the communication apparatus according to the sixteenth aspect. Further, the sending module and the receiving module may alternatively be disposed as one module, for example, a transceiver module. The transceiver module is configured to implement a sending and receiving function of the communication apparatus according to the sixteenth aspect.

Optionally, the communication apparatus according to the sixteenth aspect may further include a processing module and a storage module. The processing module is configured to implement a processing function of the communication apparatus according to the sixteenth aspect, and the storage module stores a program or instructions. When the processing module executes the program or the instructions, the communication apparatus is enabled to perform the communication method according to the eighth aspect.

It should be noted that, the communication apparatus according to the sixteenth aspect may be a terminal device, may be a chip (system) or another part or component that can be disposed in the terminal device, or may be an apparatus including the terminal device. This is not limited in this application.

In addition, for technical effects of the communication apparatuses according to the fifteenth aspect and the sixteenth aspect, refer to the technical effects of the communication method according to the seventh aspect. Details are not described herein again.

According to a seventeenth aspect, a communication apparatus is provided. The communication apparatus includes a processor. The processor is coupled to a memory. The processor is configured to execute a computer program stored in the memory, to enable the communication apparatus to perform the communication method according to any one of the first aspect to the eighth aspect.

In a possible design solution, the communication apparatus according to the seventeenth aspect may further include a transceiver. The transceiver may be a transceiver circuit or an interface circuit. The transceiver may be used by the communication apparatus according to the seventeenth aspect to communicate with another communication apparatus.

In this application, the communication apparatus according to the seventeenth aspect may be a network device or a terminal device, a chip (system) or another part or component that can be disposed in the network device or the terminal device, or an apparatus including the network device or the terminal device.

In addition, for technical effects of the communication apparatus according to the seventeenth aspect, refer to the technical effects of the communication method according to any one of the first aspect to the eighth aspect. Details are not described herein again.

According to an eighteenth aspect, a communication system is provided. The communication system includes a terminal device and a network device.

According to a nineteenth aspect, a computer-readable storage medium is provided, including a computer program or instructions. When the computer program is or the instructions are run on a computer, the computer is enabled to perform the communication method according to any one of the first aspect to the eighth aspect.

According to a twentieth aspect, a computer program product is provided, including a computer program or instructions. When the computer program is or the instructions are run on a computer, the computer is enabled to perform the communication method according to any one of the first aspect to the eighth aspect.

### BRIEF DESCRIPTION OF DRAWINGS

FIG. 1 is a diagram of an architecture of a communication system according to an embodiment of this application;

FIG. 2 is a diagram of an architecture of a satellite communication system;

FIG. 3 is a schematic flowchart of a communication method according to an embodiment of this application;

FIG. 4 is a diagram 1 of a transmission pattern of an SSB/a CORESET 0/a SIB 1 according to an embodiment of this application;

FIG. 5 is a diagram 2 of a transmission pattern of an SSB/a CORESET 0/a SIB 1 according to an embodiment of this application;

FIG. 6 is a diagram of an SSB pattern according to an embodiment of this application;

FIG. 7 is a diagram of a time-frequency resource occupied by an SSB according to an embodiment of this application;

FIG. 8 is a diagram 1 of a structure of a communication apparatus according to an embodiment of this application;

FIG. 9 is a diagram 2 of a structure of a communication apparatus according to an embodiment of this application;

FIG. 10 is a diagram 3 of a structure of a communication apparatus according to an embodiment of this application; and

FIG. 11 is a diagram 4 of a structure of a communication apparatus according to an embodiment of this application.

### DESCRIPTION OF EMBODIMENTS

The following describes technical solutions in this application with reference to accompanying drawings.

The technical solutions in embodiments of this application are applicable to various communication systems, for example, a satellite communication system, a wireless fidelity (wireless fidelity, WiFi) system, a vehicle to everything (vehicle to everything, V2X) communication system, a device-to-device (device-to-device, D2D) communication system, an internet of vehicles communication system, a 4th generation (4th generation, 4G) mobile communication system such as a long term evolution (long term evolution, LTE) system and a worldwide interoperability for microwave access (worldwide interoperability for microwave access, WiMAX) communication system, a 5th generation (5th generation, 5G) mobile communication system such as a new radio (new radio, NR) system, and a future communication system such as a 6th generation (6th generation, 6G) mobile communication system.

All aspects, embodiments, or features are presented in this application by describing a system that may include a plurality of devices, components, modules, or the like. It should be appreciated and understood that, each system may include another device, component, module, or the like, and/or may not include all devices, components, modules, or the like discussed with reference to the accompanying drawings. In addition, a combination of these solutions may be used.

In addition, in embodiments of this application, terms such as “example” and “for example” are used to represent giving an example, an illustration, or a description. Any embodiment or design solution described as an “example” in this application should not be explained as being more preferred or having more advantages than another embodiment or design solution. Exactly, the term “example” is used to present a concept in a specific manner.

In embodiments of this application, terms “information (information)”, “signal (signal)”, “message (message)”, “channel (channel)”, and “signaling (signaling)” may sometimes be interchangeably used. It should be noted that meanings expressed by the terms are consistent when differences of the terms are not emphasized. Terms “of (of)”, “corresponding, relevant (corresponding, relevant)”, and “corresponding (corresponding)” may sometimes be interchangeably used. It should be noted that meanings expressed by the terms are consistent when differences of the terms are not emphasized.

In embodiments of this application, a subscript, for example, W₁, may sometimes be mistakenly written in a non-subscript form, for example, W₁. Meanings expressed by the terms are consistent when differences of the terms are not emphasized.

The network architecture and the service scenario described in embodiments of this application are intended to describe the technical solutions in embodiments of this application more clearly, and do not constitute a limitation on the technical solutions provided in embodiments of this application. A person of ordinary skill in the art may know that, with evolution of the network architecture and emergence of a new service scenario, the technical solutions provided in embodiments of this application are also applicable to a similar technical problem.

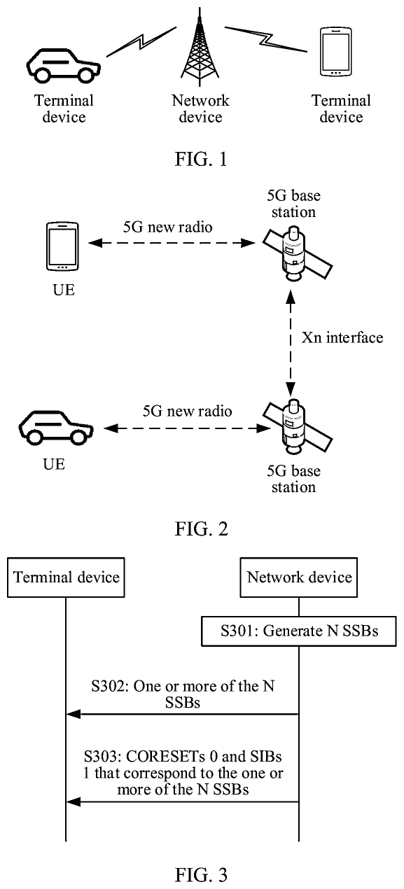

For ease of understanding embodiments of this application, a communication system shown in FIG. 1 is first used as an example to describe in detail a communication system applicable to embodiments of this application.

As shown in FIG. 1, the communication system includes a terminal device and a network device.

Optionally, the network device may be a device having a large-scale coverage area, for example, a satellite in a satellite communication system.

The network device is a device that is located on a network side of the communication system and that has a wireless sending and receiving function, or a chip or a chip system that can be disposed in the device. The network device includes but is not limited to a satellite, a high-altitude platform, an uncrewed aerial vehicle, or the like in a non-terrestrial network (non-terrestrial network, NTN) system, an access point (access point, AP) such as a home gateway, a router, a server, a switch, or a bridge in a wireless fidelity (wireless fidelity, WiFi) system, an evolved nodeB (evolved NodeB, eNB), a radio network controller (radio network controller, RNC), a nodeB (NodeB, NB), a base station controller (base station controller, BSC), a base transceiver station (base transceiver station, BTS), a home base station (for example, a home evolved NodeB, or a home NodeB, HNB), a baseband unit (baseband unit, BBU), a wireless relay node, a wireless backhaul node, a transmission and reception point or transmission point (transmission and reception point, TRP, or transmission point, TP), or the like. The network device may alternatively be a device in a 5G system, such as a gNB in a new radio (new radio, NR) system, a transmission and reception point or transmission point (TRP or TP), or one antenna panel or a group of antenna panels (including a plurality of antenna panels) of a base station in a 5G system, or may be a network node that serves as a gNB or a transmission and reception point or transmission point, such as a baseband unit (BBU), a distributed unit (distributed unit, DU), or a roadside unit (road side unit, RSU) having a base station function.

The terminal device is a terminal that accesses the communication system and that has a wireless sending and receiving function, or a chip or a chip system that can be disposed in the terminal. The terminal device may also be referred to as a user apparatus, an access terminal, a subscriber unit, a subscriber station, a mobile station, a remote station, a remote terminal, a mobile device, a user terminal, a terminal, a wireless communication device, a user agent, or a user apparatus. The terminal device in embodiments of this application may be a mobile phone (mobile phone), a pad (Pad), a computer having a wireless sending and receiving function, a virtual reality (virtual reality, VR) terminal device, an augmented reality (augmented reality, AR) terminal device, a wireless terminal in industrial control (industrial control), a wireless terminal in self driving (self driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), a vehicle-mounted terminal, an RSU having a terminal function, or the like. The terminal device in this application may alternatively be a vehicle-mounted module, a vehicle-mounted assembly, a vehicle-mounted component, a vehicle-mounted chip, or a vehicle-mounted unit that is built in a vehicle as one or more components or units. The vehicle may implement the communication method provided in this application by using the vehicle-mounted module, the vehicle-mounted assembly, the vehicle-mounted component, the vehicle-mounted chip, or the vehicle-mounted unit that is built in the vehicle.

It should be noted that, the communication method provided in embodiments of this application is applicable to communication between the terminal device and the network device shown in FIG. 1. For a specific implementation, refer to the following method embodiments. Details are not described herein.

A satellite communication system shown in FIG. 2 is used below as an example for description. The network device in FIG. 1 may be a base station, for example, a 5G base station in FIG. 2. The terminal device in FIG. 1 may be UE located on the ground in FIG. 2. In addition, the satellite communication system shown in FIG. 2 may further include a satellite ground station, a core network (core network, CN), a data network (data network, DN), and the like. It should be noted that only a 5G satellite communication system is used as an example for description in FIG. 2. This does not constitute a limitation on a communication system to which this application is applied.

Specifically, the UE on the ground accesses a network by using 5G new radio (new radio, NR), and the 5G base station is deployed on a satellite and is connected to a core network on the ground over a radio link. In addition, there is a radio link (inter-satellite link) between satellites, for completing signaling exchange and user data transmission between 5G base stations. Network elements in FIG. 2 and interfaces thereof are described as follows: UE on the ground: The UE on the ground is a mobile device that supports 5G new radio, such as a mobile phone, a pad (Pad), or a vehicle-mounted terminal, and may access a satellite network through an air interface and initiate a service such as a call or an internet access.

5G base station: The 5G base station mainly provides a radio access service, and schedules a radio resource for UE that accesses the 5G base station, to provide a reliable radio transmission service.

5G core network: The 5G core network is mainly responsible for user access control, mobility management, session management, and other services. The 5G core network may include a plurality of functional units, and may be divided into various network entities such as a control plane (control plain, CP) function and a user plane function. For example, an access and mobility management function (access and mobility management, AMF) is responsible for user access management, mobility management, and other functions, a session management function (session management function, SMF) is responsible for user session management, and the user plane function (user plain function, UPF) is responsible for management of user plane data transmission, traffic statistics collection, and other functions.

Satellite ground station: The satellite ground station is responsible for forwarding signaling and service data between the satellite base station and the 5G core network.

5G new radio: 5G new radio is a radio link between the terminal and the base station.

Xn interface: The Xn interface is an interface between 5G base stations, and is mainly used for handover and other signaling exchange.

Next generation (next generation, NG) interface: The NG interface is an interface between the 5G base station and the 5G core network, and is mainly configured to exchange non-access stratum (non-access stratum, NAS) signaling of the core network and service data of a user.

DN: The DN is responsible for providing a data service for a user, is, for example, an application server (application server, AS), and may be deployed in an operator network or a network of a third-party content provider (context provider).

It should be noted that the solutions in embodiments of this application are alternatively applicable to another communication system, and a corresponding name may be replaced with a name of a corresponding function in the another communication system, for example, a future 6G system. Correspondingly, a device that may be involved in the 6G system, for example, a 6G base station, may correspondingly support 6G.

It should be understood that FIG. 1 and FIG. 2 are merely simplified diagrams of examples for ease of understanding. The communication systems may further include other network devices and/or other terminal devices, which are not shown in FIG. 1 or FIG. 2.

With reference to FIG. 3 to FIG. 7, the following specifically describes a communication method provided in embodiments of this application.

For example, FIG. 3 is a schematic flowchart of a communication method according to an embodiment of this application. The communication method is applicable to communication between the network device and the terminal device in the communication system shown in FIG. 1, or is applicable to communication between the UE and the 5G base station in the satellite communication system shown in FIG. 2. The following uses the network device and the terminal device in FIG. 1 as an example for description.

As shown in FIG. 3, the communication method includes the following steps.

S301: The network device generates N SSBs.

The N SSBs each carry an index i, i is one of {0, 1, . . . , N−1}, N≤Lₘₐₓ, Lₘₐₓ>64, Lₘₐₓ is a maximum quantity of supported sent SSBs in one SSB cycle, and N is a quantity of SSBs actually sent in one SSB cycle. The SSB cycle may also be referred to as an SSB burst set cycle. For example, one SSB cycle may correspond to one SSB burst set, and N SSBs are sent at a time in the SSB burst set. In other words, centralized sending of N SSBs may be understood as one SSB burst set.

Currently, only a maximum of 64 beams can be supported, in other words, Lₘₐₓ=64. Therefore, when a coverage area of a single beam is relatively small, a large-scale cell cannot be fully covered. When a position of a terminal device is not covered by any beam, the terminal device may not be able to receive an SSB. Therefore, reliability of initial access of the terminal device is affected. However, in the solution provided in this embodiment of this application, more SSBs, for example, 128, 256, 512, or 1024 SSBs, may be generated, so that more beams can be supported. Therefore, a large-scale cell is fully covered, to ensure that a terminal device located at any position in the large-scale cell can receive at least one SSB, thereby improving reliability of initial access of the large-scale cell.

Further, the quantity N of actually sent SSBs may be determined based on an actual requirement, to reduce a quantity of resources occupied by SSBs, thereby improving efficiency. For example, for a small-scale cell or a densely deployed cell, a quantity of configured SSBs may be appropriately reduced. For example, a maximum of 512 SSBs are supported, and 256 or 128 SSBs are actually sent.

S302: The network device sends the N SSBs to the terminal device.

Correspondingly, the terminal device receives one or more SSBs. It may be understood that the one or more SSBs are some of the N SSBs generated by the network device.

S303: The network device sends CORESETs 0 and SIBs 1 that correspond to the N SSBs to the terminal device.

Correspondingly, the terminal device receives CORESETs 0 and SIBs 1 that correspond to the one or more SSBs.

Specifically, the network device may separately send one or more SSBs and CORESETs 0 and SIBs 1 that correspond to the one or more SSBs to different subareas in a coverage area of the network device, for beam coverage of the different subareas in the coverage area of the network device. Further, the network device may send the N SSBs and the CORESETs 0 and the SIBs 1 that respectively correspond to the N SSBs, for beam coverage of all subareas of the network device. The N SSBs each carry the index i, an SSB whose index is i in the N SSBs may be represented as an SSB #i, a CORESET 0 corresponding to the SSB #i may be represented as a CORESET 0 #i, a SIB 1 corresponding to the SSB #i may be represented as a SIB 1 #i, and i is one of {0, 1, . . . , N−1}.

In this way, any terminal device can receive at least one SSB and a CORESET 0 and a SIB 1 that correspond to the SSB, which are sent by the network device to a subarea in which the terminal device is located, and implement initial access based on the SSB and demodulation results of the CORESET 0 and the SIB 1 that correspond to the SSB.

In a possible design solution, S302 may include:

the network device sends the N SSBs on first resources. Correspondingly, the terminal device receives the one or more SSBs on first resources.

Similarly, S303 may include:
the network device sends, on second resources, the CORESETs 0 respectively corresponding to the N SSBs, and the terminal device receives, on second resources, the CORESETs 0 respectively corresponding to the one or more SSBs; and
the network device sends, on third resources, the SIBs 1 respectively corresponding to the N SSBs, and the terminal device receives, on third resources, the SIBs 1 respectively corresponding to the one or more SSBs.

A time-frequency offset between the second resource and the first resource is a first offset, and a time-frequency offset between the third resource and the first resource is a second offset. It may be understood that the first resource is a resource carrying the SSB, the second resource is a resource carrying the CORESET 0, and the third resource is a resource carrying the SIB 1.

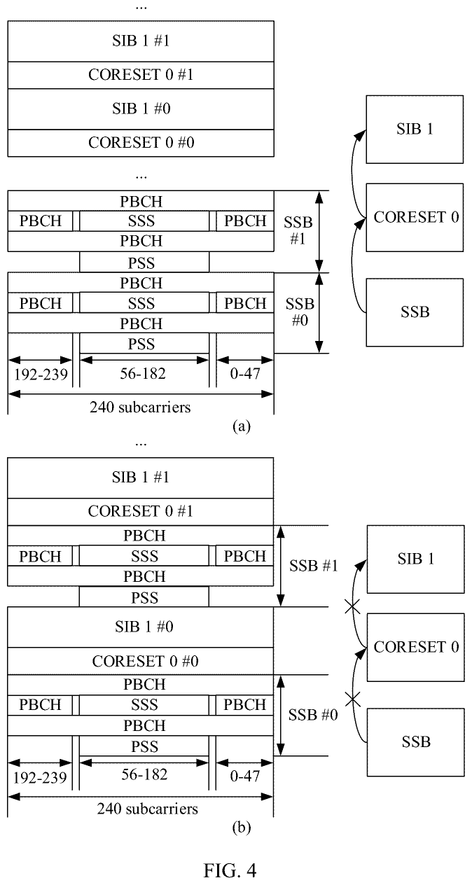

For example, (a) in FIG. 4 shows a transmission pattern of an SSB/a CORESET 0/a SIB 1, and (b) in FIG. 4 shows a transmission pattern of an SSB/a CORESET 0/a SIB 1 according to an embodiment of this application. As shown in (a) in FIG. 4, in an existing solution, an SSB carries position information of a time-frequency resource of a CORESET 0, and the CORESET 0 carries position information of a time-frequency resource of a physical downlink shared channel (physical downlink shared channel, PDSCH) carrying a SIB 1. In other words, a relative position between a first resource occupied by the SSB and a second resource occupied by the CORESET 0 is configurable, and a relative position between the first resource occupied by the SSB and a third resource occupied by the SIB 1 is also configurable. These resource configuration information needs to be transmitted by occupying specific signaling resources. Therefore, efficiency is relatively low.

Different from the existing solution, as shown in (b) in FIG. 4, in this embodiment of this application, the first resource occupied by the SSB, the second resource occupied by the CORESET 0, and the third resource occupied by the SIB 1 have fixed time-frequency positions relative to each other. Therefore, configuration information of these resources does not need to be transmitted, and saved signaling resources can be used to transmit other information, for example, an SSB index i. For example, when a maximum quantity Lₘₐₓ of supported sent SSBs increases from 64 to 256, bits indicating the SSB index increase from 6 bits (bit) to 8 bits. According to the implementation provided in this application, saved signaling resources can indicate the SSB index.

To be specific, the SSB, the CORESET 0 corresponding to the SSB, and the SIB 1 corresponding to the SSB may be separately transmitted on different time-frequency resources. In addition, there is a fixed time-frequency offset between the first resource for transmitting the SSB and the second resource for transmitting the CORESET 0, and there is a fixed time-frequency offset between the first resource for transmitting the SSB and the third resource for transmitting the SIB 1. In other words, the first resource, the second resource, and the third resource are preconfigured, and no additional configuration information is needed to indicate position relationships between the three resources. Therefore, resources originally indicating the position relationships between the three resources can be used to transmit the SSB index, to resolve a problem that signaling resources for transmitting an SSB index are insufficient when a maximum quantity of sent SSBs supported by a network increases, thereby improving reliability.

Optionally, still referring to (b) in FIG. 4, in two adjacent SSBs, a second resource and a third resource that correspond to a current SSB are located, in time domain, in front of a first resource corresponding to a next SSB. For example, resources occupied by an SSB #0, a CORESET 0 #0, and a SIB 1 #0 are contiguous in time domain, and are located, in time domain, in front of resources occupied by an SSB #1, a CORESET 0 #1, and a SIB 1 #1. In this way, a CORESET 0 and a SIB 1 that correspond to a same SSB can be transmitted together with the SSB in as short period of time as possible, so that a terminal device that receives the SSB can also receive the CORESET 0 and the SIB 1 in relatively short time, to initiate a random access procedure as early as possible, to complete initial access as soon as possible, thereby improving initial access efficiency.

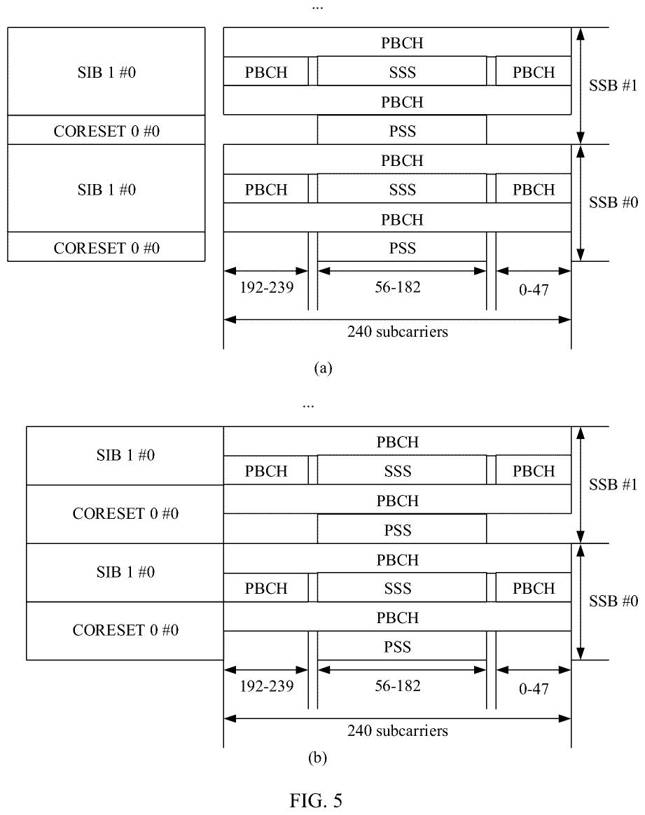

It should be noted that the first resource, the second resource, and the third resource may be contiguous or discontiguous in time domain. Similarly, the first resource, the second resource, and the third resource may be contiguous or discontiguous in frequency domain. These are not limited in this embodiment of this application. For example, as shown in (a) in FIG. 5, the first resource occupied by the SSB is discontiguous, in frequency domain, with the second resource occupied by the CORESET 0 corresponding to the SSB and the third resource occupied by the SIB 1 corresponding to the SSB. However, in (b) in FIG. 5, the first resource occupied by the SSB is contiguous, in frequency domain, with the second resource occupied by the CORESET 0 corresponding to the SSB and the third resource occupied by the SIB 1 corresponding to the SSB.

In addition, FIG. 5 and (b) in FIG. 4 are merely examples. Another SSB/CORESET 0/SIB 1 pattern may alternatively be designed to transmit the SSB/CORESET 0/SIB 1, provided that there is a fixed time-frequency offset between the first resource for transmitting the SSB and the second resource for transmitting the CORESET 0, and there is a fixed time-frequency offset between the first resource for transmitting the SSB and the third resource for transmitting the SIB 1. In other words, the first resource occupied by the SSB may be learned based on a predefined SSB pattern; and then the second resource occupied by the CORESET 0 may be learned based on the first resource and the first time-frequency offset, and the third resource occupied by the SIB 1 may be learned based on the second resource and the second time-frequency offset. According to the foregoing implementation, signaling resources originally used to transmit configuration information of the second resource and the third resource, for example, the following first information element and second information element, can be used to transmit the SSB index.

Because a quantity of SSBs that can be supported increases, and each SSB corresponds to an SSB index, namely, an SSB index, more signaling resources are needed to transmit the SSB index. This application provides a possible implementation: reusing some information elements in existing signaling, to improve resource utilization, thereby improving efficiency.

TABLE 1

| Type | Information element | Quantity of bits | Specific meaning |
|---|---|---|---|
| MIB | Choice | 1 | Indicates whether the MIB is currently an |
| | | | extended MIB message (for forward |
| | | | compatibility) |
| | SystemFrameNumber | 6 | 6 most significant bits of a system frame |
| | | | number |
| | SubCarrierSpacingCommon | 1 | Subcarrier spacing of a PDCCH and a |
| | | | PDSCH for transmitting a SIB 1 |
| | ssb-SubcarrierOffset | 4 | SSB subcarrier offset (for calculating Kssb) |
| | dmrs-TypeA-Position | 1 | Time-domain position of a DM-RS of the |
| | | | PDSCH carrying the SIB 1 |
| | pdcch-ConfigSIB1 | 8 | PDCCH configuration related to the SIB 1 |
| | cellBarred | 1 | Cell access barred flag |
| | intraFreqReselection | 1 | Intra-frequency reselection control flag |
| | spare | 1 | Spare bit |

Optionally, some of bits indicating the SSB index i may be carried by reusing a first information element and/or a second information element. Referring to Table 1, the first information element may include one or more of the following in a master information block (master information block, MIB): a common subcarrier spacing (SubCarrierSpacingCommon), an SSB subcarrier offset (SubcarrierOffset), a time domain position (dmrs-TypeA-Position) of a physical downlink shared channel PDSCH carrying a system information block SIB 1, configuration information (pdcch-ConfigSIB1) of a physical downlink control channel PDCCH related to the SIB 1, or a spare (spare) bit in the MIB. It may be understood that when the spare bit is actually used, the bit is no longer referred to as a spare bit.

Similarly, referring to Table 2, the second information element may include a half frame indication (Half Frame Indication) in a physical broadcast channel (physical broadcast channel, PBCH) payload (PBCH payload, also referred to as load).

TABLE 2

| | | Quantity | |
|---|---|---|---|
| Type | Information element | of bits | Specific meaning |
| PBCH | 4 bits LSB of SFN | 4 | 4 least significant bits |
| payload | | | of a system frame number |
| | Half Frame Indication | 1 | Half frame indication |
| | 3 bits most significant | 3 | 3 most significant bits |
| | bit of SSB Index | | of the SSB index |
| | | | (indicating that 3 least |
| | | | significant bits of the |
| | | | SSB index are in DM-RS |
| | | | for PBCH) |

Optionally, the second information element may further include X least significant bits in an information element: 4 least significant bits of system frame number (4 bits least significant bit of ystemframe number) in the PBCH payload, where X meets the following condition: X≥1 and a time length of 2 raised to the power of X system frames is greater than transmission duration of Lₘₐₓ SSBs, for example, greater than an SSB transmission period of one SSB burst set (SSB burst set). The following provides descriptions by using an example 2 and an example 3.

TABLE 3

| Type | Information element | Quantity of bits | Specific meaning |
|---|---|---|---|
| MIB | Choice | 1 | Indicates whether the MIB is currently an |
| | | | extended MIB message (for forward |
| | | | compatibility) |
| | SystemFrameNumber | 6 | 6 most significant bits of a system frame |
| | | | number |
| | SubCarrierSpacingCommon | 1 | Subcarrier spacing of a PDCCH and a |
| | | | PDSCH for transmitting a SIB 1 |
| | ssb-SubcarrierOffset | 4 | SSB subcarrier offset (for calculating Kssb) |
| | dmrs-TypeA-Position | 1 | Time-domain position of a DM-RS of the |
| | | | PDSCH carrying the SIB 1 |
| | pdcch-ConfigSIB1 | 8 | PDCCH configuration related to the SIB 1 |
| | cellBarred | 1 | Cell access barred flag |
| | intraFreqReselection | 1 | Intra-frequency reselection control flag |
| | Spare/SystemFrameNumber | 1 | In an existing solution, the 1 bit is a spare |
| | | | (Spare) bit. In this solution, the 1 bit is |
| | | | used to transmit 1 least significant bit of |
| | | | the system frame number (1 bit LSB of SFN) |

In the example 2, for example, 1024 SSBs are supported, and 10 bits are needed to indicate the SSB index. Compared with a case in which only a maximum of 64 SSBs are supported currently, and 6 bits are needed to indicate an SSB index, in this case, 4 bits need to be added to indicate the SSB index. If SCS-240 kilohertz (kilo-Hertz, kHz), there are 16 slots (slot) in total in 1 millisecond (millisecond, ms), and two SSBs are transmitted in each slot, 32 SSBs can be transmitted in 1 ms. Therefore, if 1024 SSBs are supported, a needed SSB transmission period of one SSB burst set is 32 ms, and four contiguous system frames (duration of each system frame is 10 ms) are needed in total. In this case, the four contiguous system frames may be bounded (bounding), in other words, the four contiguous system frames are placed in one system frame group. In this way, for example, a value range of the system frame number SFN is {0, 1, . . . , 1022, 1023}. 10 bits originally needed to indicate the SFN can be reduced to 8 bits, and 2 saved bits (2 least significant bits of the SFN, corresponding to X=2) can be used to transmit or indicate the SSB index i. In addition, 1 spare bit in the MIB is used and 1 bit in the half frame indication in the PBCH payload is multiplexed. A total of 4 bits are used to transmit the SSB index. For a specific solution, refer to the following Table 3 and Table 4.

TABLE 4

| | Information | Quantity | |
|---|---|---|---|
| Type | element | of bits | Specific meaning |
| PBCH | Half Frame | 1 | In an existing solution, the bit |
| payload | Indication/1 bit | | is used to transmit a half frame |
| | LSB of SFN | | indication (Half Frame Indication). |
| | | | In this solution, the bit indicates |
| | | | 1 least significant bit of a system |
| | | | frame number |
| | | | (1 bit LSB of SFN) |
| | 7 bits MSB of | 7 | 7 most significant bits of the SSB |
| | SSB Index | | index (3 least significant bits are |
| | | | in DM-RS for PBCH) |

TABLE 5

| | Information | Quantity | |
|---|---|---|---|
| Type | element | of bits | Specific meaning |
| PBCH | Half Frame | 1 | In an existing solution, the bit |
| payload | Indication/1 bit | | is used to transmit a half frame |
| | LSB of SFN | | indication (Half Frame Indication). |
| | | | In this solution, the bit is used to |
| | | | transmit 1 least significant bit of |
| | | | a system frame number |
| | 7 bits MSB of | 7 | 7 most significant bits of the SSB |
| | SSB Index | | index (3 least significant bits are |
| | | | in DM-RS for PBCH) |

It may be learned from the example 2 and the example 3 that, in the foregoing system frame bounding method, downlink timing can still be accurately determined by using a specific time domain position of the SSB in a bounded system frame, and these saved bits can be multiplexed to transmit the SSB index. This can resolve a transmission problem of the SSB index, without increasing signaling overheads.

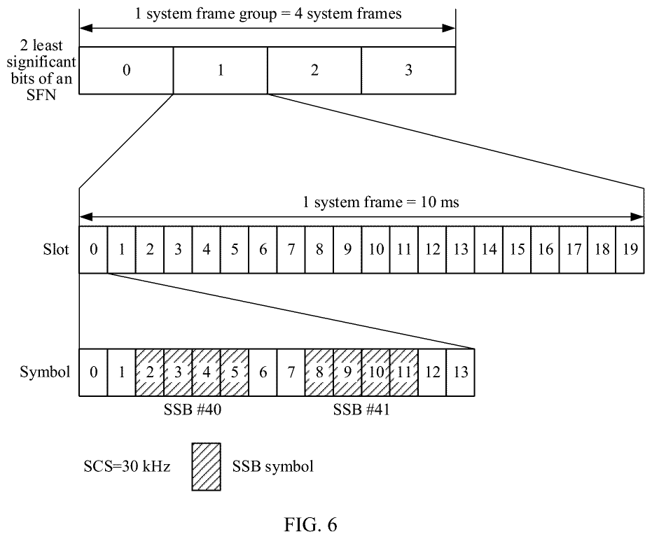

For example, FIG. 6 is a diagram of an SSB pattern according to an embodiment of this application. As shown in FIG. 6, one system frame group includes four system frames. When SCS=30 kilohertz (kilo-Hertz), one system frame includes 20 slots (slot), each slot is 0.5 ms, one slot can support two SSBs, and all slots in one system frame can be used to send SSBs, in other words, a maximum of 40 SSBs can be sent in one system frame. Assuming that a maximum quantity of supported SSBs in one SSB cycle is 128, the 128 SSBs occupy 128/40=3.2 system frames. To be specific, in the system frame group, 2 least significant bits of an SFN (SFN [1:0]) indicate three complete system frames {0, 1, 2} and first four slots in a system frame whose SFN is 3. SSBs whose SSB indexes are 0 to 39 are located in a system frame whose SFN [1:0]==0, SSBs whose SSB indexes are 40 to 79 are located in a system frame whose SFN [1:0]==1, SSBs whose SSB indexes are 80 to 119 are located in a system frame whose SFN [1:0]==2, and SSBs whose SSB indexes are 120 to 127 are located in first four slots (a slot 0 to a slot 3) in a system frame whose SFN [1:0]==0.

Referring to FIG. 6, after completing cell search, a terminal device may obtain symbol-level timing, slot-level timing, and system frame group timing. Assuming that an SSB received by the terminal device is an SSB whose index is 40 (marked as an SSB #40 in FIG. 6), the terminal device may determine that a system frame offset SFN [1:0] of the SSB #40 in the system frame group (four system frames) is a binary number 01, a slot number of the SSB #40 is 0, and the SSB #40 occupies a symbol 2 to a symbol 5. Assuming that a value range of the SFN is {0, 1, . . . , 1022, 1023}, and 8 most significant bits of the system frame number SFN [9:2] that are received by the terminal device are a binary number 00001000, it may be learned that an SFN in which the SSB #40 is located is a decimal number 33. In this way, it may be learned that complete downlink synchronization information {system frame number, slot number, symbol number} of the SSB #40 is {33, 0, 2 to 5}.

The foregoing example 1 to example 3 describe how to multiply some information elements in existing signaling to indicate an SSB index obtained after a quantity of SSBs increases. For example, the quantity of SSBs increases from 64 to 1024, and bits of the SSB index increase from 6 bits to 10 bits. In the SSB index, 4 added most significant bits may be indicated in the manners in the foregoing example 1 to example 3, and 6 least significant bits may still be indicated in an existing manner. As shown in Table 2, Table 4, and Table 5, 3 least significant bits of the SSB index may still be indicated by an information element: a PBCH reference signal (DM-RS for PBCH).

It should be noted that an added bit in the SSB index may alternatively be transmitted by adding a time-frequency resource. Optionally, the added time-frequency resource may include a resource that has been defined in an existing protocol but is not actually used.

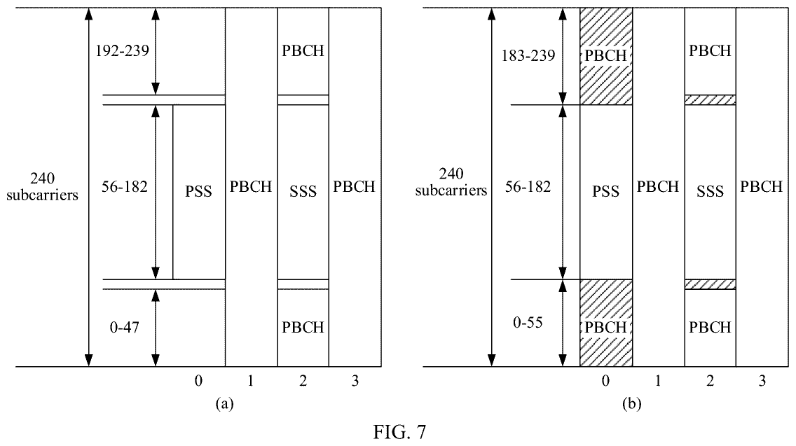

In an implementation, as shown in (a) in FIG. 7, the first resource may occupy, in time domain, four symbols whose symbol indexes are {0, 1, 2, 3}, and occupy, in frequency domain, 240 subcarriers whose subcarrier indexes are {0, 1, . . . , 239}; and the first resource may include a fourth resource occupied by a physical broadcast channel PBCH, and the fourth resource may include subcarriers whose subcarrier indexes are {0, 1, . . . , 238, 239} on a symbol 1 and a symbol 3 and subcarriers whose subcarrier indexes are {0, 1, . . . , 47} and {192, 193, . . . , 239} on a symbol 2.

Optionally, as shown in (b) in FIG. 7, the fourth resource may further include some or all of the following one or more subcarriers: subcarriers whose indexes are {0, 1, . . . , 55} on a symbol 0, subcarriers whose subcarrier indexes are {183, 184, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2.

Because a quantity of supported SSBs increases, a quantity of resources or bits indicating or carrying the SSB index also needs to increase. In the foregoing implementation, a quantity of resources of the PBCH for transmitting the SSB index may be increased. For example, the SSB index may be transmitted by using a resource that is spare for the SSB but is not actually used (referring to resources filled with slashes in (b) in FIG. 7), to resolve a problem of insufficient resources indicating the SSB index. In addition, these added resources and original PBCH resources all belong to resources that can be configured for the SSB, and a time-frequency resource other than currently defined SSB time-frequency resources (four contiguous symbols in time domain and 240 contiguous subcarriers in frequency domain) does not need to be added. In this way, transmission of other signaling and/or data is not affected, thereby improving communication efficiency.

It should be noted that the solution, in the foregoing example 1 to example 3, of reusing some information elements in existing signaling to transmit the SSB index and the solution, shown in (b) in FIG. 7, of adding a time-frequency resource of the SSB may be independently implemented, or may be implemented in combination. This is not limited in this embodiment of this application. For example, some of bits indicating the SSB index may be transmitted by using the reusing solution in the example 1 to example 3, and the other bits may be transmitted by using the solution shown in (b) in FIG. 7.

Based on the method shown in FIG. 3, the network device may support sending of more than 64 SSBs, for example, 256 or 1024 SSBs, and actually send N of the more than 64 SSBs in one SSB cycle, to meet a full-area coverage requirement of a large-scale area (for example, a satellite cell), so that a terminal device located at any position in the area can receive at least one SSB, to implement initial access, thereby improving reliability of initial access of a large-scale cell.

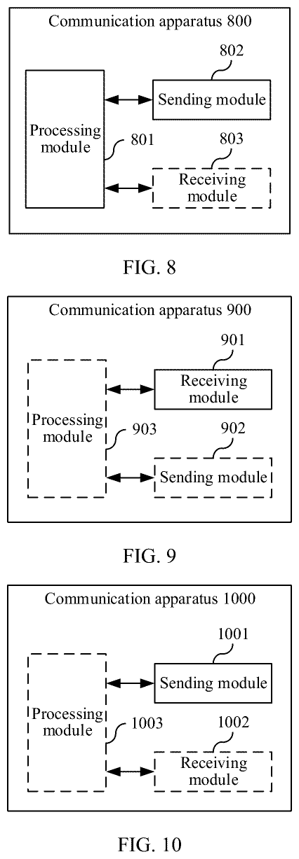

With reference to FIG. 3 to FIG. 7, the foregoing describes in detail the communication method provided in embodiments of this application. With reference to FIG. 8 to FIG. 11, the following describes in detail a communication apparatus provided for performing embodiments of this application.

For example, FIG. 8 is a diagram 1 of a structure of a communication apparatus according to an embodiment of this application. As shown in FIG. 8, a communication apparatus 800 includes a processing module 801 and a sending module 802. For ease of description, FIG. 8 shows only main components of the communication apparatus.

In some embodiments, the communication apparatus 800 is applicable to the communication system shown in FIG. 1 and performs the function of the network device in the communication method shown in FIG. 3, or is applicable to the satellite communication system shown in FIG. 2 and performs the function of the 5G base station.

The processing module 801 is configured to generate N SSBs, where the N SSBs each carry an index i, i is one of {0, 1, . . . , N−1}, N≤Lₘₐₓ, Lₘₐₓ>64, Lₘₐₓ is a maximum quantity of supported sent SSBs, and Nis a quantity of SSBs actually sent in one SSB cycle. The sending module 802 is configured to send the N SSBs.

In a possible design solution, the sending module 802 is further configured to send the N SSBs on first resources. The sending module 802 is further configured to send, on second resources, control resource sets CORESETs 0 respectively corresponding to the N SSBs, where a time-frequency offset between the second resource and the first resource is a first offset. The sending module 802 is further configured to send, on third resources, system messages SIBs 1 respectively corresponding to the N SSBs, where a time-frequency offset between the third resource and the first resource is a second offset.

Optionally, in two adjacent SSBs, a second resource and a third resource that correspond to a current SSB are located, in time domain, in front of a first resource corresponding to a next SSB.

Optionally, the first resource may occupy, in time domain, four symbols whose symbol indexes are {0, 1, 2, 3}, and may occupy, in frequency domain, 240 subcarriers whose subcarrier indexes are {0, 1, . . . , 239}; and the first resource may include a fourth resource occupied by a physical broadcast channel PBCH, and the fourth resource may include subcarriers whose subcarrier indexes are {0, 1, . . . , 238, 239} on a symbol 1 and a symbol 3 and subcarriers whose subcarrier indexes are {0, 1, . . . , 48} and {192, 193, . . . , 239} on a symbol 2. Further, the fourth resource may further include some or all of the following one or more subcarriers: subcarriers whose subcarrier indexes are {0, 1, . . . , 48} on a symbol 0, subcarriers whose subcarrier indexes are {192, 193, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2.

In a possible design solution, some of bits indicating the index i may be carried by reusing a first information element and/or a second information element. The first information element may include one or more of the following items in a master information block MIB: a common subcarrier spacing, an SSB subcarrier offset, a time domain position of a physical downlink shared channel PDSCH carrying a system information block SIB 1, configuration information of a physical downlink control channel PDCCH related to the SIB 1, or a spare bit. The second information element may include one or more of the following items in a physical broadcast channel PBCH payload: a half frame indication or X least significant bits in 4 least significant bits of a system frame number, where X meets the following condition: X≥1 and a time length of 2 raised to the power of X system frames is greater than transmission duration of Lₘₐₓ SSBs.

Optionally, the communication apparatus 800 may further include a receiving module 803. The receiving module 803 is configured to implement a receiving function of the communication apparatus 800. Further, the sending module 802 and the receiving module 803 may alternatively be disposed as one module, for example, a transceiver module (not shown in FIG. 8). The transceiver module is configured to implement a sending and receiving function of the communication apparatus 800.

Optionally, the communication apparatus 800 may further include a storage module (not shown in FIG. 8). The storage module stores a program or instructions. When the processing module 801 executes the program or the instructions, the communication apparatus 800 is enabled to perform the communication method shown in FIG. 3.

It should be noted that, the communication apparatus 800 may be a network device, may be a chip (system) or another part or component that can be disposed in the network device, or may be an apparatus including the network device. This is not limited in this application.

In addition, for technical effects of the communication apparatus 800, refer to the technical effects of the communication method shown in FIG. 3. Details are not described herein again.

For example, FIG. 9 is a diagram 2 of a structure of a communication apparatus according to an embodiment of this application. As shown in FIG. 9, a communication apparatus 900 includes a receiving module 901. For ease of description, FIG. 9 shows only main components of the communication apparatus.

In some embodiments, the communication apparatus 900 is applicable to the communication system shown in FIG. 1 and performs the function of the terminal device in the communication method shown in FIG. 3, or is applicable to the satellite communication system shown in FIG. 2 and performs the function of the UE on the ground.

The receiving module 901 is configured to receive one or more SSBs, where the one or more SSBs each carry an index i, i is one of {0, 1, . . . , N−1}, N≤Lₘₐₓ, Lₘₐₓ>64, Lₘₐₓ is a maximum quantity of supported sent SSBs, N is a quantity of SSBs actually sent in one SSB cycle, and the one or more SSBs are some of N SSBs generated by a network device. The receiving module 901 is further configured to receive control resource sets 0 CORESETs 0 respectively corresponding to the one or more SSBs.

In a possible design solution, the receiving module 901 is further configured to receive the one or more SSBs on first resources. The receiving module 901 is further configured to receive, on second resources, the control resource sets 0 CORESETs 0 respectively corresponding to the one or more SSBs, where a time-frequency offset between the second resource and the first resource is a first offset. The receiving module 901 is further configured to receive, on third resources, system messages 1 SIBs 1 corresponding to the one or more SSBs, where a time-frequency offset between the third resource and the first resource is a second offset.

Optionally, in two adjacent SSBs, a second resource and a third resource that correspond to a current SSB are located, in time domain, in front of a first resource corresponding to a next SSB.

Optionally, the first resource may occupy, in time domain, four symbols whose symbol indexes are {0, 1, 2, 3}, and may occupy, in frequency domain, 240 subcarriers whose subcarrier indexes are {0, 1, . . . , 239}; and the first resource may include a fourth resource occupied by a physical broadcast channel PBCH, and the fourth resource may include subcarriers whose subcarrier indexes are {0, 1, . . . , 239, 239} on a symbol 1 and a symbol 3 and subcarriers whose subcarrier indexes are {0, 1, . . . , 47} and {192, 193, . . . , 239} on a symbol 2. Further, the fourth resource may further include some or all of the following one or more subcarriers: subcarriers whose subcarrier indexes are {0, 1, . . . , 47} on a symbol 0, subcarriers whose subcarrier indexes are {192, 193, . . . , 239} on the symbol 0, subcarriers whose subcarrier indexes are {49, 49, . . . , 55} on the symbol 2, or subcarriers whose subcarrier indexes are {193, 194, . . . , 191} on the symbol 2.

In a possible design solution, some bits in the index i may be carried by reusing a first information element and/or a second information element. The first information element may include one or more of the following items in a master information block MIB: a common subcarrier spacing, an SSB subcarrier offset, a time domain position of a physical downlink shared channel PDSCH carrying a system information block SIB 1, configuration information of a physical downlink control channel PDCCH related to the SIB 1, or a spare bit. The second information element may include one or more of the following items in a physical broadcast channel PBCH payload: a half frame indication or X least significant bits in 4 least significant bits of a system frame number, where X meets the following condition: X≥1 and a time length of 2 raised to the power of X system frames is greater than transmission duration of Lₘₐₓ SSBs.

Optionally, the communication apparatus 900 may further include a sending module 902. The sending module 902 is configured to implement a sending function of the communication apparatus 900. Further, the sending module 902 and the receiving module 901 may alternatively be disposed as one module, for example, a transceiver module (not shown in FIG. 9). The transceiver module is configured to implement a sending and receiving function of the communication apparatus 900.

Optionally, the communication apparatus 900 may further include a processing module 903 and a storage module (not shown in FIG. 9). The processing module 903 is configured to implement a processing function of the communication apparatus 900, and the storage module stores a program or instructions. When the processing module 903 executes the program or the instructions, the communication apparatus 900 is enabled to perform the communication method shown in FIG. 3.

It should be noted that, the communication apparatus 900 may be a terminal device, may be a chip (system) or another part or component that can be disposed in the terminal device, or may be an apparatus including the terminal device. This is not limited in this application.

In addition, for technical effects of the communication apparatus 900, refer to the technical effects of the communication method shown in FIG. 3. Details are not described herein again.

For example, FIG. 10 is a diagram 3 of a structure of a communication apparatus according to an embodiment of this application. As shown in FIG. 10, a communication apparatus 1000 includes a sending module 1001. For ease of description, FIG. 10 shows only main components of the communication apparatus.

In some embodiments, the communication apparatus 1000 is applicable to the communication system shown in FIG. 1 and performs the function of the network device in the communication method shown in FIG. 3, or is applicable to the satellite communication system shown in FIG. 2 and performs the function of the 5G base station.

The sending module 1001 is configured to send N SSBs on first resources, where the N SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle. The sending module 1001 is further configured to send, on second resources, control resource sets CORESETs 0 respectively corresponding to the N SSBs, where a time-frequency offset between the second resource and the first resource is a first offset. The sending module 1001 is further configured to send, on third resources, system messages SIBs 1 respectively corresponding to the N SSBs, where a time-frequency offset between the third resource and the first resource is a second offset.

Optionally, in two adjacent SSBs, a second resource and a third resource that correspond to a current SSB are located, in time domain, in front of a first resource corresponding to a next SSB.

In a possible design solution, some bits in the index i may be carried by reusing a first information element and/or a second information element. The first information element may include one or more of the following items in a master information block MIB: a common subcarrier spacing, an SSB subcarrier offset, a time domain position of a physical downlink shared channel PDSCH carrying a system information block SIB 1, configuration information of a physical downlink control channel PDCCH related to the SIB 1, or a spare bit. The second information element may include one or more of the following items in a physical broadcast channel PBCH payload: a half frame indication or X least significant bits in 4 least significant bits of a system frame number, where X meets the following condition: X≥1 and a time length of 2 raised to the power of X system frames is greater than transmission duration of Lₘₐₓ SSBs.

Optionally, the communication apparatus 1000 may further include a receiving module 1002. The receiving module 1002 is configured to implement a receiving function of the communication apparatus 1000. Further, the sending module 1001 and the receiving module 1002 may alternatively be disposed as one module, for example, a transceiver module (not shown in FIG. 10). The transceiver module is configured to implement a sending and receiving function of the communication apparatus 1000.

Optionally, the communication apparatus 1000 may further include a processing module 1003 and a storage module (not shown in FIG. 10). The processing module 1003 is configured to implement a processing function of the communication apparatus 1000, and the storage module stores a program or instructions. When the processing module 1003 executes the program or the instructions, the communication apparatus 1000 is enabled to perform the communication method shown in FIG. 3.

It should be noted that, the communication apparatus 1000 may be a network device, may be a chip (system) or another part or component that can be disposed in the network device, or may be an apparatus including the network device. This is not limited in this application.

In addition, for technical effects of the communication apparatus 1000, refer to the technical effects of the communication method shown in FIG. 3. Details are not described herein again.

In some other embodiments, the communication apparatus 900 is applicable to the communication system shown in FIG. 1 and performs the function of the terminal device in the communication method shown in FIG. 3, or is applicable to the satellite communication system shown in FIG. 2 and performs the function of the UE on the ground.

The receiving module 901 is configured to receive one or more SSBs on first resources, where the one or more SSBs each carry an index i, i is one of {0, 1, . . . , N−1}, N≤Lₘₐₓ, Lₘₐₓ>64, Lₘₐₓ is a maximum quantity of supported sent SSBs, N is a quantity of SSBs actually sent in one SSB cycle, and the one or more SSBs are some of N SSBs generated by a network device. The receiving module 901 is further configured to receive, on second resources, control resource sets 0 CORESETs 0 respectively corresponding to the one or more SSBs, where a time-frequency offset between the second resource and the first resource is a first offset. The receiving module 901 is further configured to receive, on third resources, system messages 1 SIBs 1 respectively corresponding to the one or more SSBs, where a time-frequency offset between the third resource and the first resource is a second offset.

Optionally, in two adjacent SSBs, a second resource and a third resource that correspond to a current SSB are located, in time domain, in front of a first resource corresponding to a next SSB.

In a possible design solution, some bits in the index i may be carried by reusing a first information element and/or a second information element. The first information element may include one or more of the following items in a master information block MIB: a common subcarrier spacing, an SSB subcarrier offset, a time domain position of a physical downlink shared channel PDSCH carrying a system information block SIB 1, configuration information of a physical downlink control channel PDCCH related to the SIB 1, or a spare bit. The second information element may include one or more of the following items in a physical broadcast channel PBCH payload: a half frame indication or X least significant bits in 4 least significant bits of a system frame number, where X meets the following condition: X≥1 and a time length of 2 raised to the power of X system frames is greater than transmission duration of Lₘₐₓ SSBs.

Optionally, the communication apparatus 900 may further include a sending module 902. The sending module 902 is configured to implement a sending function of the communication apparatus 900. Further, the sending module 902 and the receiving module 901 may alternatively be disposed as one module, for example, a transceiver module (not shown in FIG. 9). The transceiver module is configured to implement a sending and receiving function of the communication apparatus 900.

Optionally, the communication apparatus 900 may further include a processing module 903 and a storage module (not shown in FIG. 9). The processing module 903 is configured to implement a processing function of the communication apparatus 900, and the storage module stores a program or instructions. When the processing module 903 executes the program or the instructions, the communication apparatus 900 is enabled to perform the communication method shown in FIG. 3.

It should be noted that, the communication apparatus 900 may be a terminal device, may be a chip (system) or another part or component that can be disposed in the terminal device, or may be an apparatus including the terminal device. This is not limited in this application.

In addition, for technical effects of the communication apparatus 900, refer to the technical effects of the communication method shown in FIG. 3. Details are not described herein again.

In some other embodiments, the communication apparatus 800 is applicable to the communication system shown in FIG. 1 and performs the function of the network device in the communication method shown in FIG. 3, or is applicable to the satellite communication system shown in FIG. 2 and performs the function of the 5G base station.

The processing module 801 is configured to generate N SSBs, where the N SSBs each carry an index i, i is one of {0, 1, . . . , N−1}, N≤Lₘₐₓ, Lₘₐₓ>64, Lₘₐₓ is a maximum quantity of supported sent SSBs, and Nis a quantity of SSBs actually sent in one SSB cycle. The sending module 802 is configured to send the N SSBs on first resources. The first resource occupies, in time domain, four symbols whose symbol indexes are {0, 1, 2, 3}, and occupies, in frequency domain, 240 subcarriers whose subcarrier indexes are {0, 1, . . . , 239}; and the first resource includes a fourth resource occupied by a physical broadcast channel PBCH, and the fourth resource includes subcarriers whose subcarrier indexes are {0, 1, . . . , 238, 239} on a symbol 1 and a symbol 3 and subcarriers whose subcarrier indexes are {0, 1, . . . , 48} and {192, 193, . . . , 239} on a symbol 2. The fourth resource further includes some or all of the following one or more subcarriers: subcarriers whose subcarrier indexes are {0, 1, . . . , 48} on a symbol 0, subcarriers whose subcarrier indexes are {192, 193, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2.

Optionally, the communication apparatus 800 may further include a receiving module 803. The receiving module 803 is configured to implement a receiving function of the communication apparatus 800. Further, the sending module 802 and the receiving module 803 may alternatively be disposed as one module, for example, a transceiver module (not shown in FIG. 8). The transceiver module is configured to implement a sending and receiving function of the communication apparatus 800.

Optionally, the communication apparatus 800 may further include a storage module (not shown in FIG. 8). The storage module stores a program or instructions. When the processing module 801 executes the program or the instructions, the communication apparatus 800 is enabled to perform the communication method shown in FIG. 3.

It should be noted that, the communication apparatus 800 may be a network device, may be a chip (system) or another part or component that can be disposed in the network device, or may be an apparatus including the network device. This is not limited in this application.

In addition, for technical effects of the communication apparatus 800, refer to the technical effects of the communication method shown in FIG. 3. Details are not described herein again.

In some still other embodiments, the communication apparatus 900 is applicable to the communication system shown in FIG. 1 and performs the function of the terminal device in the communication method shown in FIG. 3, or is applicable to the satellite communication system shown in FIG. 2 and performs the function of the UE.

The receiving module 901 is configured to receive one or more SSBs on first resources, where the one or more SSBs each carry an index i, i is one of {0, 1, . . . , N−1}, N≤Lₘₐₓ, Lₘₐₓ>64, Lₘₐₓ is a maximum quantity of supported sent SSBs, N is a quantity of SSBs actually sent in one SSB cycle, and the one or more SSBs are some of N SSBs generated by a network device. The first resource occupies, in time domain, four symbols whose symbol indexes are {0, 1, 2, 3}, and occupies, in frequency domain, 240 subcarriers whose subcarrier indexes are {0, 1, . . . , 239}; and the first resource includes a fourth resource occupied by a physical broadcast channel PBCH, and the fourth resource includes subcarriers whose subcarrier indexes are {0, 1, . . . , 239, 239} on a symbol 1 and a symbol 3 and subcarriers whose subcarrier indexes are {0, 1, . . . , 47} and {192, 193, . . . , 239} on a symbol 2. The fourth resource further includes some or all of the following one or more subcarriers: subcarriers whose subcarrier indexes are {0, 1, . . . , 47} on a symbol 0, subcarriers whose subcarrier indexes are {192, 193, . . . , 239} on the symbol 0, subcarriers whose subcarrier indexes are {49, 49, . . . , 55} on the symbol 2, or subcarriers whose subcarrier indexes are {193, 194, . . . , 191} on the symbol 2. The receiving module 901 is further configured to receive control resource sets 0 CORESETs 0 respectively corresponding to the one or more SSBs.

Optionally, the communication apparatus 900 may further include a sending module 902. The sending module 902 is configured to implement a sending function of the communication apparatus 900. Further, the sending module 902 and the receiving module 901 may alternatively be disposed as one module, for example, a transceiver module (not shown in FIG. 9). The transceiver module is configured to implement a sending and receiving function of the communication apparatus 900.

Optionally, the communication apparatus 900 may further include a processing module 903 and a storage module (not shown in FIG. 9). The processing module 903 is configured to implement a processing function of the communication apparatus 900, and the storage module stores a program or instructions. When the processing module 903 executes the program or the instructions, the communication apparatus 900 is enabled to perform the communication method shown in FIG. 3.

It should be noted that, the communication apparatus 900 may be a terminal device, may be a chip (system) or another part or component that can be disposed in the terminal device, or may be an apparatus including the terminal device. This is not limited in this application.

In addition, for technical effects of the communication apparatus 900, refer to the technical effects of the communication method shown in FIG. 3. Details are not described herein again.

In some still other embodiments, the communication apparatus 800 is applicable to the communication system shown in FIG. 1 and performs the function of the network device in the communication method shown in FIG. 3, or is applicable to the satellite communication system shown in FIG. 2 and performs the function of the 5G base station.

The processing module 801 is configured to generate N SSBs, where the N SSBs each carry an index i, i is one of {0, 1, . . . , N−1}, N≤Lₘₐₓ, Lₘₐₓ>64, Lₘₐₓ is a maximum quantity of supported sent SSBs, and Nis a quantity of SSBs actually sent in one SSB cycle. The sending module 802 is configured to send the N SSBs. Some bits in the index i are carried by reusing a spare bit in a master information block MIB and/or a second information element, where the second information element includes one or more of the following items: a half frame indication or X least significant bits in 4 least significant bits of a system frame number in a physical broadcast channel PBCH payload, where X meets the following condition: X≥1 and a time length of 2 raised to the power of X system frames is greater than transmission duration of Lₘₐₓ SSBs.

Optionally, the communication apparatus 800 may further include a receiving module 803. The receiving module 803 is configured to implement a receiving function of the communication apparatus 800. Further, the sending module 802 and the receiving module 803 may alternatively be disposed as one module, for example, a transceiver module (not shown in FIG. 8). The transceiver module is configured to implement a receiving function of the communication apparatus 800.

Optionally, the communication apparatus 800 may further include a storage module (not shown in FIG. 8). The storage module stores a program or instructions. When the processing module 801 executes the program or the instructions, the communication apparatus 800 is enabled to perform the communication method shown in FIG. 3.

It should be noted that, the communication apparatus 800 may be a network device, may be a chip (system) or another part or component that can be disposed in the network device, or may be an apparatus including the network device. This is not limited in this application.

In addition, for technical effects of the communication apparatus 800, refer to the technical effects of the communication method shown in FIG. 3. Details are not described herein again.

In some yet other embodiments, the communication apparatus 900 is applicable to the communication system shown in FIG. 1 and performs the function of the terminal device in the communication method shown in FIG. 3, or is applicable to the satellite communication system shown in FIG. 2 and performs the function of the UE.

The receiving module 901 is configured to receive one or more SSBs, where the one or more SSBs each carry an index i, i is one of {0, 1, . . . , N−1}, N≤Lₘₐₓ, Lₘₐₓ>64, Lₘₐₓ is a maximum quantity of supported sent SSBs, N is a quantity of SSBs actually sent in one SSB cycle, and the one or more SSBs are some of N SSBs generated by a network device, where some bits in the index i are carried by reusing a spare bit in a master information block MIB and/or a second information element, where the second information element includes one or more of the following items: a half frame indication or X least significant bits in 4 least significant bits of a system frame number in a physical broadcast channel PBCH payload, where X meets the following condition: X≥1 and a time length of 2 raised to the power of X system frames is greater than transmission duration of Lₘₐₓ SSBs. The receiving module 901 is further configured to receive control resource sets 0 CORESETs 0 respectively corresponding to the one or more SSBs.

Optionally, the communication apparatus 900 may further include a sending module 902. The sending module 902 is configured to implement a sending function of the communication apparatus 900. Further, the sending module 902 and the receiving module 901 may alternatively be disposed as one module, for example, a transceiver module (not shown in FIG. 9). The transceiver module is configured to implement a sending and receiving function of the communication apparatus 900.

Optionally, the communication apparatus 900 may further include a processing module 903 and a storage module (not shown in FIG. 9). The processing module 903 is configured to implement a processing function of the communication apparatus 900, and the storage module stores a program or instructions. When the processing module 903 executes the program or the instructions, the communication apparatus 900 is enabled to perform the communication method shown in FIG. 3.

It should be noted that, the communication apparatus 900 may be a terminal device, may be a chip (system) or another part or component that can be disposed in the terminal device, or may be an apparatus including the terminal device. This is not limited in this application.

In addition, for technical effects of the communication apparatus 900, refer to the technical effects of the communication method shown in FIG. 3. Details are not described herein again.

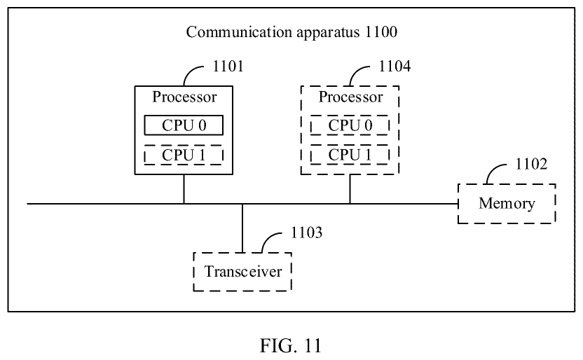

For example, FIG. 11 is a diagram 4 of a structure of a communication apparatus according to an embodiment of this application. The communication apparatus may be a terminal device or a network device, or may be a chip (system) or another part or component that can be disposed in the terminal device or the network device. As shown in FIG. 11, a communication apparatus 1100 may include a processor 1101. Optionally, the communication apparatus 1100 may further include a memory 1102 and/or a transceiver 1103. The processor 1101 is coupled to the memory 1102 and the transceiver 1103. For example, the processor 1101 may be connected to the memory 1102 and the transceiver 1103 through a communication bus.

The following specifically describes components of the communication apparatus 1100 with reference to FIG. 11.

The processor 1101 is a control center of the communication apparatus 1100, and may be one processor, or may be a general term of a plurality of processing elements. For example, the processor 1101 is one or more central processing units (central processing unit, CPU), may be an application-specific integrated circuit (application specific integrated circuit, ASIC), or is configured as one or more integrated circuits for implementing embodiments of this application, for example, one or more microprocessors (digital signal processor, DSP) or one or more field programmable gate arrays (field programmable gate array, FPGA).

Optionally, the processor 1101 may perform various functions of the communication apparatus 1100 by running or executing a software program stored in the memory 1102 and invoking data stored in the memory 1102.

During specific implementation, as an embodiment, the processor 1101 may include one or more CPUs, for example, a CPU 0 and a CPU 1 shown in FIG. 11.

During specific implementation, as an embodiment, the communication apparatus 1100 may alternatively include a plurality of processors, for example, the processor 1101 and a processor 1104 shown in FIG. 11. Each of the processors may be a single-core (single-CPU) processor or may be a multi-core (multi-CPU) processor. The processor herein may be one or more devices, circuits, and/or processing cores configured to process data (for example, computer program instructions).

The memory 1102 is configured to store a software program for performing the solutions in this application, and the processor 1101 controls execution of the software program. For a specific implementation, refer to the foregoing method embodiments. Details are not described herein again.

Optionally, the memory 1102 may be a read-only memory (read-only memory, ROM) or another type of static storage device that can store static information and instructions, or a random access memory (random access memory, RAM) or another type of dynamic storage device that can store information and instructions, or may be an electrically erasable programmable read-only memory (electrically erasable programmable read-only memory, EEPROM), a compact disc read-only memory (compact disc read-only memory, CD-ROM) or another compact disc storage, an optical disc storage (including a compact disc, a laser disc, an optical disc, a digital versatile disc, a Blu-ray disc, or the like), a magnetic disk storage medium or another magnetic storage device, or any other medium that can be configured to carry or store expected program code in a form of an instruction structure or a data structure and that is accessible by a computer, but is not limited thereto. The memory 1102 may be integrated with the processor 1101, or may exist independently and be coupled to the processor 1101 through an interface circuit (not shown in FIG. 11) of the communication apparatus 1100. This is not specifically limited in this embodiment of this application.

The transceiver 1103 is configured to communicate with another communication apparatus. For example, the communication apparatus 1100 is a terminal device, and the transceiver 1103 may be configured to communicate with a network device or communicate with another terminal device. For another example, the communication apparatus 1100 is a network device, and the transceiver 1103 may be configured to communicate with a terminal device or communicate with another network device.

Optionally, the transceiver 1103 may include a receiver and a transmitter (not separately shown in FIG. 11). The receiver is configured to implement a receiving function, and the transmitter is configured to implement a sending function.

Optionally, the transceiver 1103 may be integrated with the processor 1101, or may exist independently and be coupled to the processor 1101 through an interface circuit (not shown in FIG. 11) of the communication apparatus 1100. This is not specifically limited in this embodiment of this application.

It should be noted that the structure of the communication apparatus 1100 shown in FIG. 11 does not constitute a limitation on the communication apparatus. An actual communication apparatus may include more or fewer components than those shown in the figure, combine some components, or have a different component arrangement.

In addition, for technical effects of the communication apparatus 1100, refer to the technical effects of the communication method in the foregoing method embodiments. Details are not described herein again.

An embodiment of this application provides a communication system. The communication system includes a terminal device and a network device.

It should be understood that, the processor in embodiments of this application may be a central processing unit (central processing unit, CPU), or the processor may be another general-purpose processor, a digital signal processor (digital signal processor, DSP), an application-specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

It may be understood that the memory in embodiments of this application may be a volatile memory or a nonvolatile memory, or may include a volatile memory and a nonvolatile memory. The nonvolatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), used as an external cache. Through an example rather than a limitative description, random access memories (random access memory, RAM) in many forms may be used, for example, a static random access memory (static RAM, SRAM), a dynamic random access memory (DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

All or some of the foregoing embodiments may be implemented by using software, hardware (for example, circuit), firmware, or any combination thereof. When software is used to implement the foregoing embodiments, all or some of the foregoing embodiments may be implemented in a form of a computer program product. The computer program product includes one or more computer instructions or computer programs. When the computer instructions or the computer programs are loaded and executed on a computer, all or some of the procedures or functions according to embodiments of this application are generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium. The semiconductor medium may be a solid-state drive.

It should be understood that the term “and/or” in this specification describes only an association relationship between associated objects and indicates that three relationships may exist. For example, A and/or B may indicate the following three cases: Only A exists, both A and B exist, and only B exists, where A and B may be singular or plural. In addition, the character “/” in this specification usually indicates an “or” relationship between associated objects, but may alternatively indicate an “and/or” relationship. For details, refer to the context for understanding.

In this application, “at least one” means one or more, and “a plurality of” means two or more. “At least one of the following items (pieces)” or a similar expression thereof is any combination of these items, including any combination of singular items (pieces) or plural items (pieces). For example, at least one of a, b, or c may indicate: a, b, c, a-b, a-c, b-c, or a-b-c, where a, b, and c may be singular or plural.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application.

A person of ordinary skill in the art may be aware that, in combination with the examples described in embodiments disclosed in this specification, units and algorithm steps can be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, to be specific, may be located in one place, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this application essentially, the part contributing to the conventional technology, or a part of the technical solutions may be implemented in a form of a software product. The computer software product is stored in a storage medium, and includes several instructions for enabling a computer device (which may be a personal computer, a server, a network device, or the like) to perform all or some of the steps of the methods described in embodiments of this application. The foregoing storage medium includes any medium that can store program code, such as a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication method, comprising:
generating N SSBs, wherein the N SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle; and
sending the N SSBs.

2. The communication method according to claim 1, wherein the sending the N SSBs comprises:
sending the N SSBs on first resources;
sending, on second resources, control resource sets CORESETs 0 respectively corresponding to the N SSBs, wherein a time-frequency offset between the second resource and the first resource is a first offset; and
sending, on third resources, system messages SIBs 1 respectively corresponding to the N SSBs, wherein a time-frequency offset between the third resource and the first resource is a second offset.

3. The communication method according to claim 2, wherein in two adjacent SSBs, a second resource and a third resource that correspond to a current SSB are located, in time domain, in front of a first resource corresponding to a next SSB.

4. The communication method according to claim 2, wherein the first resource occupies, in time domain, four symbols whose symbol indexes are {0, 1, 2, 3}, and occupies, in frequency domain, 240 subcarriers whose subcarrier indexes are {0, 1, . . . , 239}; and the first resource comprises a fourth resource occupied by a physical broadcast channel, PBCH, and the fourth resource comprises subcarriers whose subcarrier indexes are {0, 1, . . . , 239} on a symbol 1 and a symbol 3 and subcarriers whose subcarrier indexes are {0, 1, . . . , 47} and {192, 193, . . . , 239} on a symbol 2; and
the fourth resource further comprises some or all of the following one or more subcarriers: subcarriers whose subcarrier indexes are {0, 1, . . . , 55} on a symbol 0, subcarriers whose subcarrier indexes are {183, 184, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2.

5. The communication method according to claim 1, wherein some of bits indicating the index i are carried by reusing a first information element and/or a second information element;
the first information element comprises one or more of the following items in a master information block, MIB: a common subcarrier spacing, an SSB subcarrier offset, a time domain position of a physical downlink shared channel, PDSCH carrying a system information block, SIB 1, configuration information of a physical downlink control channel, PDCCH related to the SIB 1, or a spare bit; and
the second information element comprises one or more of the following items in a physical broadcast channel, PBCH payload: a half frame indication or X least significant bits in 4 least significant bits of a system frame number, wherein X meets the following condition: X≥1 and a time length of 2 raised to the power of X system frames is greater than transmission duration of Lₘₐₓ SSBs.

6. A communication method, comprising:
receiving one or more SSBs, wherein the one or more SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle; and
receiving control resource sets 0 CORESETs 0 respectively corresponding to the one or more SSBs.

7. The communication method according to claim 6, wherein the receiving one or more SSBs comprises:
receiving the one or more SSBs on first resources;
receiving, on second resources, the control resource sets 0 CORESETs 0 respectively corresponding to the one or more SSBs, wherein a time-frequency offset between the second resource and the first resource is a first offset; and
receiving, on third resources, system messages 1 SIBs 1 corresponding to the one or more SSBs, wherein a time-frequency offset between the third resource and the first resource is a second offset.

8. The communication method according to claim 7, wherein in two adjacent SSBs, a second resource and a third resource that correspond to a current SSB are located, in time domain, in front of a first resource corresponding to a next SSB.

9. The communication method according to claim 7, wherein the first resource occupies, in time domain, four symbols whose symbol indexes are {0, 1, 2, 3}, and occupies, in frequency domain, 240 subcarriers whose subcarrier indexes are {0, 1, . . . , 239}; and the first resource comprises a fourth resource occupied by a physical broadcast channel, PBCH, and the fourth resource comprises subcarriers whose subcarrier indexes are {0, 1, . . . , 238, 239} on a symbol 1 and a symbol 3 and subcarriers whose subcarrier indexes are {0, 1, . . . , 47} and {192, 193, . . . , 239} on a symbol 2; and
the fourth resource further comprises some or all of the following one or more subcarriers: subcarriers whose subcarrier indexes are {0, 1, . . . , 55} on a symbol 0, subcarriers whose subcarrier indexes are {183, 184, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2.

10. The communication method according to claim 6, wherein some bits in the index i are carried by reusing a first information element and/or a second information element;
the first information element comprises one or more of the following items in a master information block, MIB: a common subcarrier spacing, an SSB subcarrier offset, a time domain position of a physical downlink shared channel, PDSCH carrying a system information block, SIB 1, configuration information of a physical downlink control channel, PDCCH related to the SIB 1, or a spare bit; and
the second information element comprises one or more of the following items in a physical broadcast channel, PBCH payload: a half frame indication or X 4 least significant bits in 4 least significant bits of a system frame number, wherein X meets the following condition: X≥1 and a time length of 2 raised to the power of X system frames is greater than transmission duration of Lₘₐₓ SSBs.

11. A communication apparatus, comprising at least one processor and one or more memories coupled to the at least one processor, wherein the one or more memories store programming instructions for execution by the at least one processor to perform a method comprising:
generating N SSBs, wherein the N SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle; and
sending the N SSBs.

12. The apparatus according to claim 11, wherein the sending the N SSBs comprises:
sending the N SSBs on first resources;
sending, on second resources, control resource sets CORESETs 0 respectively corresponding to the N SSBs, wherein a time-frequency offset between the second resource and the first resource is a first offset; and
sending, on third resources, system messages SIBs 1 respectively corresponding to the N SSBs, wherein a time-frequency offset between the third resource and the first resource is a second offset.

13. The apparatus according to claim 12, wherein in two adjacent SSBs, a second resource and a third resource that correspond to a current SSB are located, in time domain, in front of a first resource corresponding to a next SSB.

14. The apparatus according to claim 12, wherein the first resource occupies, in time domain, four symbols whose symbol indexes are {0, 1, 2, 3}, and occupies, in frequency domain, 240 subcarriers whose subcarrier indexes are {0, 1, . . . , 239}; and the first resource comprises a fourth resource occupied by a physical broadcast channel, PBCH, and the fourth resource comprises subcarriers whose subcarrier indexes are {0, 1, . . . , 239} on a symbol 1 and a symbol 3 and subcarriers whose subcarrier indexes are {0, 1, . . . , 47} and {192, 193, . . . , 239} on a symbol 2; and
the fourth resource further comprises some or all of the following one or more subcarriers: subcarriers whose subcarrier indexes are {0, 1, . . . , 55} on a symbol 0, subcarriers whose subcarrier indexes are {183, 184, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2.

15. The apparatus according to claim 11, wherein some of bits indicating the index i are carried by reusing a first information element and/or a second information element;
the first information element comprises one or more of the following items in a master information block, MIB: a common subcarrier spacing, an SSB subcarrier offset, a time domain position of a physical downlink shared channel, PDSCH carrying a system information block, SIB 1, configuration information of a physical downlink control channel, PDCCH related to the SIB 1, or a spare bit; and
the second information element comprises one or more of the following items in a physical broadcast channel, PBCH payload: a half frame indication or X least significant bits in 4 least significant bits of a system frame number, wherein X meets the following condition: X≥1 and a time length of 2 raised to the power of X system frames is greater than transmission duration of Lₘₐₓ SSBs.

16. A communication apparatus, comprising at least one processor and one or more memories coupled to the at least one processor, wherein the one or more memories store programming instructions for execution by the at least one processor to perform a method comprising:
receiving one or more SSBs, wherein the one or more SSBs each carry an index i, i is one of {0, 1, . . . , N−1}, N≤Lₘₐₓ, Lₘₐₓ>64, Lₘₐₓ is a maximum quantity of supported sent SSBs, and N is a quantity of SSBs actually sent in one SSB cycle; and
receiving control resource sets 0 CORESETs 0 respectively corresponding to the one or more SSBs.

17. The apparatus according to claim 16, wherein the receiving one or more SSBs comprises:
receiving the one or more SSBs on first resources;
receiving, on second resources, the control resource sets 0 CORESETs 0 respectively corresponding to the one or more SSBs, wherein a time-frequency offset between the second resource and the first resource is a first offset; and
receiving, on third resources, system messages 1 SIBs 1 corresponding to the one or more SSBs, wherein a time-frequency offset between the third resource and the first resource is a second offset.

18. The apparatus according to claim 17, wherein in two adjacent SSBs, a second resource and a third resource that correspond to a current SSB are located, in time domain, in front of a first resource corresponding to a next SSB.

19. The apparatus according to claim 17, wherein the first resource occupies, in time domain, four symbols whose symbol indexes are {0, 1, 2, 3}, and occupies, in frequency domain, 240 subcarriers whose subcarrier indexes are {0, 1, . . . , 239}; and the first resource comprises a fourth resource occupied by a physical broadcast channel, PBCH, and the fourth resource comprises subcarriers whose subcarrier indexes are {0, 1, . . . , 238, 239} on a symbol 1 and a symbol 3 and subcarriers whose subcarrier indexes are {0, 1, . . . , 47} and {192, 193, . . . , 239} on a symbol 2; and
the fourth resource further comprises some or all of the following one or more subcarriers: subcarriers whose subcarrier indexes are {0, 1, . . . , 55} on a symbol 0, subcarriers whose subcarrier indexes are {183, 184, . . . , 239} on the symbol 0, subcarriers whose subcarrier indexes are {48, 49, . . . , 55} on the symbol 2, or subcarriers whose subcarrier indexes are {183, 184, . . . , 191} on the symbol 2.

20. The apparatus according to claim 16, wherein some bits in the index i are carried by reusing a first information element and/or a second information element;
the first information element comprises one or more of the following items in a master information block, MIB: a common subcarrier spacing, an SSB subcarrier offset, a time domain position of a physical downlink shared channel, PDSCH carrying a system information block, SIB 1, configuration information of a physical downlink control channel, PDCCH related to the SIB 1, or a spare bit; and
the second information element comprises one or more of the following items in a physical broadcast channel, PBCH payload: a half frame indication or X 4 least significant bits in 4 least significant bits of a system frame number, wherein X meets the following condition: X≥1 and a time length of 2 raised to the power of X system frames is greater than transmission duration of Lₘₐₓ SSBs.
